(19) United States
(12) Patent Application Publication
(10) Pub. No.: US 2002/0017759 A1
(43) Pub. Date: Feb. 14, 2002

(54) Flying disc with compact disc

(76) Inventors: Guy L. McClung III, Springs, TX (US); Charlie H. VanNatter III, Pearland, TX (US)

Correspondence Address: Guy McClung, 16690 Champion Forest Drive, Spring, TX, 77379-7023, US

(21) Appl. No.: 09/863,634

(22) Filed: May 23, 2001

Related U.S. Application Data
(63) Continuation-in-part of application No. 09/592,976, filed on Jun. 12, 2000.
Application No. 09/592,976 is a continuation-in-part of application No. 09/144,002, filed on Aug. 31, 1998, now Pat. No. 6,073,588.
Application No. 09/144,002 is a division of application No. 08/711,259, filed on Sep. 9, 1996, now Pat. No. 5,799,616.
Application No. 08/711,259 is a continuation-in-part of application No. 08/338,675, filed on Nov. 14, 1994, now Pat. No. 5,553,570.

(51) Int. Cl. A01K 29/00; A63B 65/10; A63B 67/06

(52) U.S. Cl. 273/317; 119/709; 473/588; 119/710; 119/51.01; 446/46; 446/5

(57) ABSTRACT

A flying disc with a disc body and a compact or computer disc on the disc body; in one aspect the compact or computer disc disposed between a first flying disc and a second flying disc; and, in one aspect, the second flying disc releasably attached to the first flying disc.

### RELATED APPLICATIONS

This is a continuation-in-part of U.S. application Ser. No. 09/592,976 filed Jun. 12, 2000 which is a continuation-in-part of U.S. application Ser. No. 09/144,002 filed Aug. 31, 1998 issued as U.S. Pat. No. 6,073,588 on Jun. 13, 2000 which is a division of U.S. application Ser. No. 09/711,259 filed Sep. 9, 1996 issued as U.S. Pat. No. 5,799,616 on Sep. 1, 1998 which is a continuation-in-part of U.S. application Ser. No. 08/338,675 filed Nov. 14, 1994 issued as U.S. Pat. No. 5,553,570 on Sep. 10, 1996—all said applications as filed and patents as issued incorporated fully herein for all purposes.

### BACKGROUND OF THE INVENTION

1. Field Of The Invention

This invention is directed to, among other things, a flying disc with a compact disc thereon or attached thereto.

2. Description of Related Art

The prior art discloses a variety of flying discs, including, but not limited to the well-known FRISBEE (TM) flying disc. The prior art discloses various compact and computer discs used in computers and in various appliances for playing or recording music, or for playing or recording audio recordings such as, but not limited to, books and plays.

### SUMMARY OF THE PRESENT INVENTION

The present invention, in certain embodiments, discloses a flying disc with a disc body and a compact disc or computer disc on the disc body. Such a flying disc may include securement apparatus (e.g., but not limited to, tape, adhesive, glue, and/or a mechanical securement device) on the disc body for releasably securing the other disc to the disc body, the other disc releasably secured to the disc body by the securement apparatus. Such a flying disc may have a disc body that has a recess therein for holding the compact or computer disc releasably emplaced in the recess; and in one aspect the recess has a lower wall, and a hole through the lower wall, the hole disposed beneath the computer disc, the hole suitable for insertion of a member therethrough to facilitate ejection of the computer or compact. disc (“other disc”) from the recess. Any such flying disc may have, according to the present invention, a support member on the disc body for supporting the other disc, the other disc releasably disposed in the support member. In one aspect the support member is a hollow sleeve with two open spaced apart ends or with only one open end and in another aspect the support member is a chamber suitable for housing the other disc, the chamber with a side wall extending down from an underside of the disc body and a bottom wall with an end connected to the side wall. In one such aspect the flying disc has a disc body that has a top side and a bottom side and the support member is on the bottom side. In one aspect a flying disc according to the present invention has at least one clip on the disc body for releasably holding an item, e.g, but not limited to, a paper, a booklet, and/or compact or computer disc.

Any flying disc as mentioned above may have a disc body that has a recess therein for holding the other disc and the other disc releasably emplaced in the recess; in one aspect with at least one clip on the disc body for releasably holding an item.

Any flying disc according to the present invention may have a disc body as viewed from above, with a shape that is oval, circular, triangular, square, rectangular, pentagonal, hexagonal, septagonal, octagonal, and monagonal.

The present invention discloses, in certain embodiments, a flying disc system with a first disc body, the first disc body including a first flying disc, at least one first slit or opening through the first disc body, at least one second disc, the at least one second disc body releasably disposed in the at least one first slit or opening. In such a system the at least one second disc body may be a second flying disc or a compact or computer disc; and the at least one first slit or opening is a plurality of spaced-apart first slits or openings, and the at least one second disc body is a plurality of second disc bodies, one second disc body in each of the first slits or openings of the plurality of spaced-apart slits or openings. In certain embodiments each second disc body has identifying indicia thereon. In certain embodiments there is a plurality of or at least one secondary opening through the at least one second disc body, and at least one secondary disc body releasably disposed in the at least one secondary disc opening. In certain embodiments there is reception apparatus on the first disc body for receiving and releasably holding a support device for supporting the first disc body in an upright position; and in one aspect the support device is the at least second disc body and part of the at last one second disc body is releasably held in the reception apparatus. In certain aspects the at least one secondary disc body is a secondary flying disc; and in other aspects the at least one secondary disc body is a plurality of secondary disc bodies. In certain aspects each secondary disc body has identifying indicia thereon; and in one aspect the plurality of secondary disc bodies is a plurality of flying discs.

The present invention discloses, in at least certain embodiments, a flying disc system with a first flying disc, a second flying disc nested within the first flying disc, and a compact or computer disc disposed between the first flying disc and the second flying disc.

The present invention discloses, in certain aspects, a method for at least one first person to interact with at least one second person, the method including the at least one first person throwing a plurality of flying discs, each of the plurality of flying discs bearing identifying indicia, and the at least one second person retrieving at least one of the plurality of flying discs. In other aspects the at least one second person is a plurality of second persons; the plurality of second persons compete with each other to retrieve flying discs thrown by the at least one first person; and/or the plurality of second persons comprises at least two separate competing teams, each team including a plurality of persons.

In certain aspects, the present invention discloses a container with a hollow container body with at least one open end, a flying disc with a disc body, and the flying disc removably secured at the at least one open end of the hollow container body and closing off said at least one open end. In another aspect the present invention provides a flying disc with a disc body, and a CD-ROM disc, credit card, smart card, or other electronic or memory-containing card to the disc body. In another aspect the present invention discloses a flying disc with a disc body, and an amount of releasable attachment material on the disc body.

In other embodiments a team of a plurality of players competes with another team of a plurality of players to retrieve one or more flying discs thrown either by a neutral person or persons or by one team to the other; or one team throws discs to another team or teams without competing in disc retrieval. Scoring can be based on time for retrieval of one or more discs or one or more discs with certain indicia thereon or scoring can be based on retrieving discs with certain scoring points indicated thereon. Indicia can be on discs themselves or on some member releasably connected to or attached to a disc.

The present invention in one embodiment discloses a toy retrievable by an animal such as a dog or cat, the toy having a body with two joined yet releasable parts, one or both of which have a hollow portion therein or a holding device thereon for holding an item, animal treat, or food item and for preventing the animal from having access to the item until a person opens the body or releases the item from a holding device.

In one embodiment the body of the toy either has a portion of one part which is transparent or the entire part is transparent so that an animal can see a food treat, an item, or a picture within the body. Another embodiment according to the present invention includes a food item or items in a transparent wrapper or container which is held to or on the body. In one such embodiment an interior mirror is emplaced at a location in the toy so that it is viewable from the toy's exterior.

In one embodiment the two parts of the body have mating threads so the parts are screwable together. In another embodiment two parts are held together with a friction fit and/or a snap fit. In certain embodiments the body is shaped like a bone, or like a small animal that a larger animal would eat. In another embodiment the body is shaped as a flying toy plate or Frisbee (TM) device. In one aspect such a device is solid with an interior chamber or recess for holding an item, a treat, or food item.

In one embodiment the present invention discloses a series of devices as disclosed above of different colors and/or with different indicia (e.g. letters, symbols, or numbers thereon). In one method according to this invention for using such devices an item, a treat or food item is placed in only one of the devices and an animal (or person) is asked to retrieve that device according to its indicia from among a plurality of devices.

In another embodiment the body has a pocket or other container therein or thereon for holding a card or photograph.

Other embodiments include one, more, or any combination of all of the features listed above.

In another aspect a toy according to this invention has releasably secured thereto a container, envelope, or package with a food item therein, e.g. a piece of cheese, meat, dog food, cat food or candy; and in one aspect the container, envelope or package is transparent or has a transparent portion which reveals to an animal retrieving the toy or to a human being observing or using the toy the contents thereof. In one aspect a photograph or pictorial representation or other indicia is on a photograph or card emplaced in the container, envelope, or package. In one aspect a releasable adhesive material is used, either on the container etc., on a surface of the toy, or both, to hold the container etc. in place as the toy is used and/or thrown. In another aspect releasably cooperating material, e.g. Velcro (TM) material, is used to secure the container etc. to the toy.

It is, therefore, an object of at least certain preferred embodiments of the present invention to provide:

New, useful, unique, efficient, nonobvious flying discs and activities and/or games with them;

Such discs with identifying indicia thereon or on a member removably attached or connected thereto;

Such discs with a CD-ROM disc thereon or therein; and

Games or activities for teams using such discs.

It is, therefore, an object of at least certain preferred embodiments of the present invention to provide:

New, useful, unique, efficient, nonobvious animal toys which hold a treat food item or other item therein or thereon;

Such devices with a transparent portion or apparatus for revealing the food item or other item;

Such devices with two securable but separable parts; and

Methods for using such devices for play and for education with animals or human beings.

Certain embodiments of this invention are not limited to any particular individual feature disclosed here, but include combinations of them distinguished from the prior art in their structures and functions. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the previously-mentioned problems and long-felt needs and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1A is a perspective view of an artificial dog bone according to the present invention.

FIG. 1B is a cross-sectional view of the bone of FIG. 1A.

FIG. 1C is a cross-sectional view of another embodiment of a bone according to the present invention which is similar to the bone of FIG. 1A.

FIG. 2 is a perspective view of an artificial dog bone according to the present invention with interior aspects shown with dotted lines.

FIG. 3A is a side view of a flying retrieval toy according to the present invention.

FIG. 3B is a side cross-sectional view of the toy of FIG. 3A.

FIG. 3C is a bottom view of the toy of FIG. 3A.

FIG. 4A is a side cross-sectional view of a flying retrieval toy according to the present invention.

FIG. 4B is a top view of the toy of FIG. 4A.

FIGS. 4C and 4D show a top view of a food treat or item according to the present invention.

FIG. 4E shows a side view of a food treat or item according to the present invention.

FIGS. 5A and 5B are side cross-section views of systems according to the present invention.

FIG. 6A shows a perspective view of an artificial mouse toy according to the present invention.

FIG. 6B shows an exploded view, partially in cross-section, of the mouse of FIG. 6A.

FIG. 6C shows an artificial mouse toy according to the present invention.

FIG. 7A shows a perspective view of an artificial mouse toy according to the present invention.

FIG. 7B shows an exploded view, partially in cross-section, of the mouse of FIG. 6A.

FIG. 7C shows an artificial mouse toy according to the present invention.

FIG. 8A is a side view of a throwing plate according to the present invention.

FIG. 8B is a top view of the plate of FIG. 8A.

FIG. 8C is a bottom view of the plate of FIG. 8A.

FIG. 8D is a crosssectional view along line 8D-8D of FIG. 8B.

FIG. 9A is a side view of a throwing plate according to the present invention.

FIG. 9B is a top view of the plate of FIG. 9A.

FIG. 9C is a bottom view of the plate of FIG. 9A.

FIG. 9D is a crosssectional view along line 9D-9D of FIG. 9B.

FIG. 10A is a side view of a throwing plate according to the present invention.

FIG. 10B is a top view of the plate of FIG. 10A.

FIG. 10C is a bottom view of the plate of FIG. 10A.

FIG. 10D is a crosssectional view along line 10D-10D of FIG. 10B.

FIG. 11A is a side view of a throwing plate according to the present invention.

FIG. 11B is a top view of the plate of FIG. 11A.

FIG. 11C is a bottom view of the plate of FIG. 11A.

FIG. 11D is a crosssectional view along line 11D-11D of FIG. 11B.

FIG. 12A is a bottom view of a throwing plate according to the present invention.

FIG. 12B is a crosssectional view along line 12B-12B of FIG. 12A.

FIG. 13A is a bottom view of a throwing plate according to the present invention.

FIG. 13B is a crosssectional view along line 13B-13B of FIG. 13A.

FIG. 14 is a side view in crosssection of a throwing plate according to the present invention.

FIG. 15 is a side view in crosssection of a throwing plate according to the present invention.

FIG. 16 is a perspective view of a toy, food item, score indicators or item according to the present invention.

FIG. 17A is a side crosssection view of a throwing plate according to the present invention.

FIG. 17B is a side crosssectional view of an item according to the present invention.

FIG. 18 is a side view in crosssection of an item according to the present invention.

FIG. 19A is a side view in crosssection of a throwing plate according to the present invention.

FIG. 19B is top view of the plate of FIG. 19A.

FIG. 20A is a side view in crosssection of a throwing plate according to the present invention.

FIG. 20B is a top view of the plate of FIG. 20A.

FIG. 21A is a side view in crosssection of a throwing plate according to the present invention.

FIG. 21B is a top view of the plate of FIG. 21A.

FIG. 22A is a side view of a throwing plate according to the present invention.

FIG. 22B is a top view of the plate of FIG. 22A.

FIG. 22C is a bottom view of the plate of FIG. 22A.

FIG. 22D is a crosssectional view along line 22D-22D of FIG. 22B.

FIG. 23A is a side view of a throwing plate according to the present invention.

FIG. 23B is a top view of Me plate of FIG. 23A.

FIG. 23C is a bottom view of the plate of FIG. 23A.

FIG. 23D is a crosssectional view along line 23D-23D of FIG. 23B.

FIG. 24A is a front view of a prior art CD-ROM container.

FIG. 24B is a rear view of the container of FIG. 24A.

FIG. 24C shows the container of FIG. 24A open.

FIG. 24D shows the CD-ROM from the container as shown in FIG. 24C.

FIG. 24E is a side view of the container of FIG. 24E.

FIG. 25A is a top view of a flying disc with CD-ROM according to the present invention.

FIG. 25B is a bottom view of the disc of FIG. 25A.

FIG. 25C is a side view of the disc of FIG. 25A.

FIG. 25D is a bottom view of a flying disc according to the present invention.

FIG. 26 is a side cross-section view of a flying disc according to the present invention.

FIG. 27A is a side cross-section view of a flying disc according to the present invention.

FIG. 27B is a bottom view of the disc of FIG. 27A.

FIGS. 28-31 are side cross-section views of flying discs according to the present invention.

FIG. 32A is a side view of a flying disc according to the present invention.

FIGS. 32B-32E are bottom views of discs as in FIG. 32A.

FIG. 33A is a side cross-section view of a flying disc according to the present invention.

FIG. 33B is an exploded view of the disc of FIG. 33A.

FIG. 33C is a top view,

and FIG. 33D is a bottom view of the disc of FIG. 33A.

FIG. 33E shows top views of various embodiments of part of the disc of FIG. 33A.

FIG. 33F, 33G and 33H are side cross-section views of a flying disc according to the present invention.

FIG. 34 is a perspective view of a body with garments according to the present invention.

FIG. 35 is a top view of a plurality of flying discs according to the present invention.

FIG. 36 is a side cross-section view of a container according to the present invention.

FIG. 37A is a side cross-section view of a container according to the present invention.

FIG. 37B is an exploded view of the container of FIG. 37A.

FIG. 38 and 41 are schematic representations for a game area for a game according to the present invention.

FIGS. 39, 42 and 43A are top views and FIG. 43B is a side view of systems according to the present invention.

FIGS. 40, 44, and 45 are side cross-section views of systems according to the present invention.

### DESCRIPTION OF EMBODIMENTS PREFERRED AT THE TIME OF FILING FOR THIS PATENT

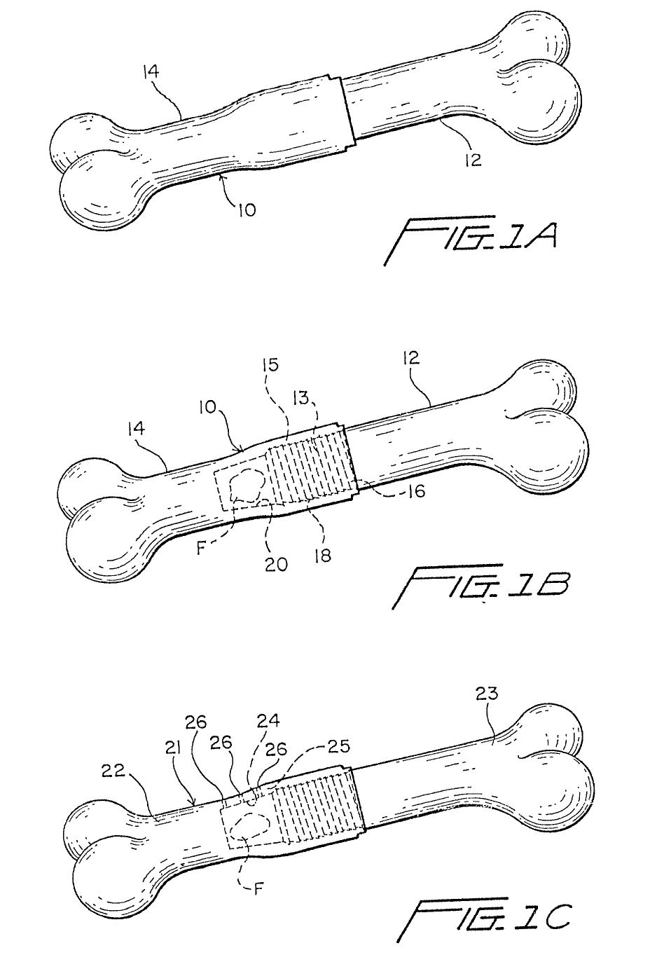

FIGS. 1A and 1B show a retrieval device 10 according to the present invention which is generally shaped like a bone. The device 10 has two releasably separable parts 12 and 14 which are releasably secured together with exterior threads 16 or an end 13 of the part 12 and interior threads 18 on an end 15 of the part 14. A treat or food item F is removably confined in an interior chamber 20 of the part 14. After an animal retrieves the device 10, a person unscrews the two parts 12 and 14 and either removes the item F and gives it to the animal as a reward or lets the item F roll out from the interior chamber 20.

A device 21 according to the present invention is shown in FIG. 1C which is similar to the device 10 of FIG. 1A. The same numerals in FIGS, 1A and 1C indicate the same structure. An end 22 of the device 21 is releasably securable to an end 23. A treat or food item F is disposed in all interior chamber 24 formed in the part 22. A transparent piece 25 over all or a portion of the chamber 24 permits visual access to the item F while it is in the chamber 24. Optionally one or more vent holes 26 serve as air holes and/or permit an aroma from the item F to escape from the chamber 20 to further interest an animal in retrieving the device 21 and/or to provide a sensory indicator of the location of the device 21, e.g. if it is hidden in tall grass or under water. A mirror M is viewable through the transparent piece 25. A transparent piece 25 may be used with any embodiment of the present invention disclosed or described herein.

FIG. 2 illustrates a device 30 according to the present invention which has two parts 32 and 34 releasably secured together by a friction fit between an end 38 of the part 34 and an end 36 of the part 32. A treat, food item, or other item F is disposed in an interior chamber 40 of the part 32. Known snap-fit mechanisms (not shown) may be used with the two ends 36 and 38 for further securement of the two parts.

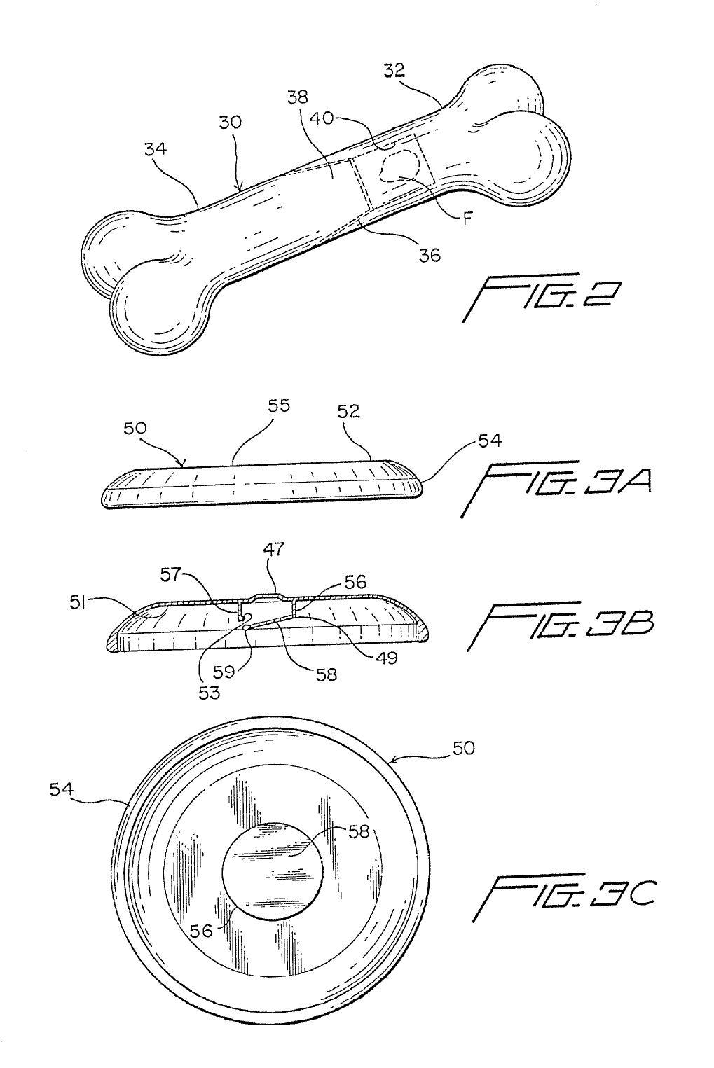

FIGS. 3A-3C show a generally plate-shaped flying retrieval toy 50 according to the present invention which has a body 52 with a top surface 55 and a lateral edge 54. A container 56 is secured to or formed of a bottom surface 51 of the body 52. An item F is removably emplaceable in the container 56. The container 56 may be releasably secured to the bottom surface 51 with a suitable adhesive, mechanical structure (e.g. a clip), or releasably cooperating fastener (e.g. VELCRO (TM) material). The container 56 has a sidewall 57 and a hinged lid 58 connected, e.g. with a living hinge 49 to the side wall 57. The lid 58 may be releasably securable to the side wall 57 with a snap-fit structure that includes, e.g. a bead 59 on the lid 58 and a bead recess 53 on the side wall 57. Alternatively the lid 58 may be releasably received and held within the interior periphery of the side wall 57. A portion 47 of the body 52 may be transparent; alternatively any device according to this invention may be made entirely of transparent material.

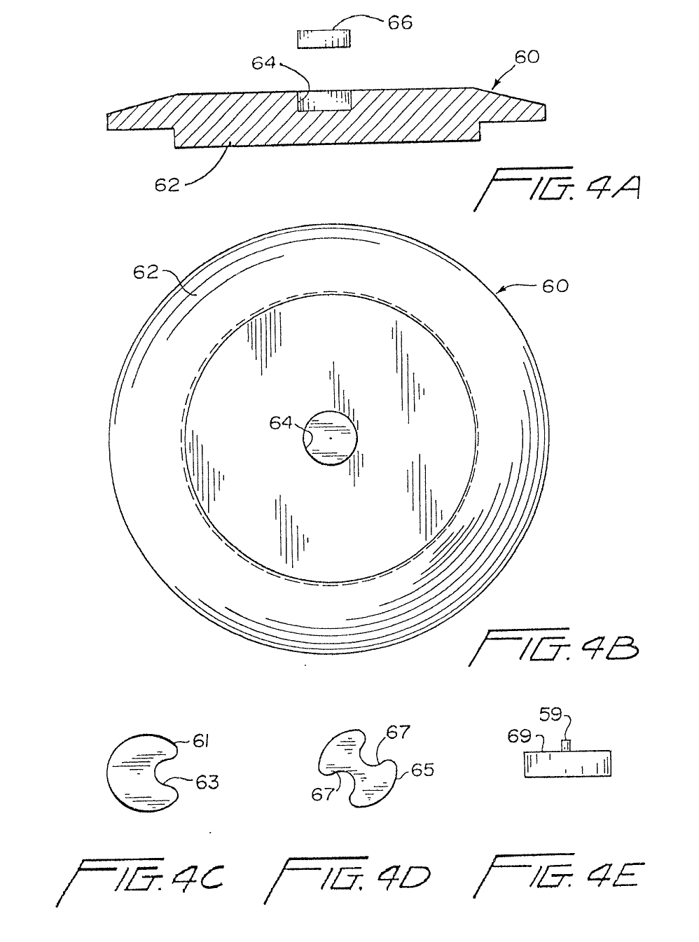

FIGS. 4A and 4B show a generally plate-shaped flying retrieval toy 60 according to the present invention that has a main body 62 with a recess 64 therein for receiving and holding a treat, food item, or other item 66. In one aspect, proper sizing of the recess 64 and item 66 results in a friction fit of the item 66 in the recess 64 rendering it difficult or impossible for an animal to remove the item 66 from the recess 64. Indentation(s), hole(s) or a raised portion on the item 66 will facilitate removal from the recess 64 by a person. A recess such as the recess 64 may be positioned anywhere in the body 62 and two or more such recesses may be used on The same or different sides of the body 62. FIG. 4D shows a food treat or item 61, like the item 66, but with an indentation 63 to facilitate handling and removal from a recess. FIG. 4E shows a food treat or item 65, like the treat 61, but with two indentations 67 FIG. 41 shows a food treat or item 69 with a raised portion 59 to facilitate handling and removal from a recess. Although the items 61, 65, and 69 are shows as generally cylindrical, they may be any shape or configuration usable with a recess of any suitable shape or configuration, e.g. but not limited to cone-shaped, cubic, etc.

FIG. 5A shows a flying retrieval toy 70 according to the present invention which has two parts 72 and 74 releasably held together by a friction fit of an end 76 of the part 72 held within an end 78 of The part 74 to form a generally plate-shaped plate member. An item E is held in an interior chamber 75 of the part 74. FIG. 5B shows a plate 100 with a body 102 and a top 104 and a bottom surface 108 with an L-shaped (when viewed in cross-section) container member having a bottom side 106 and an open end 110 through which a food piece F is movable.

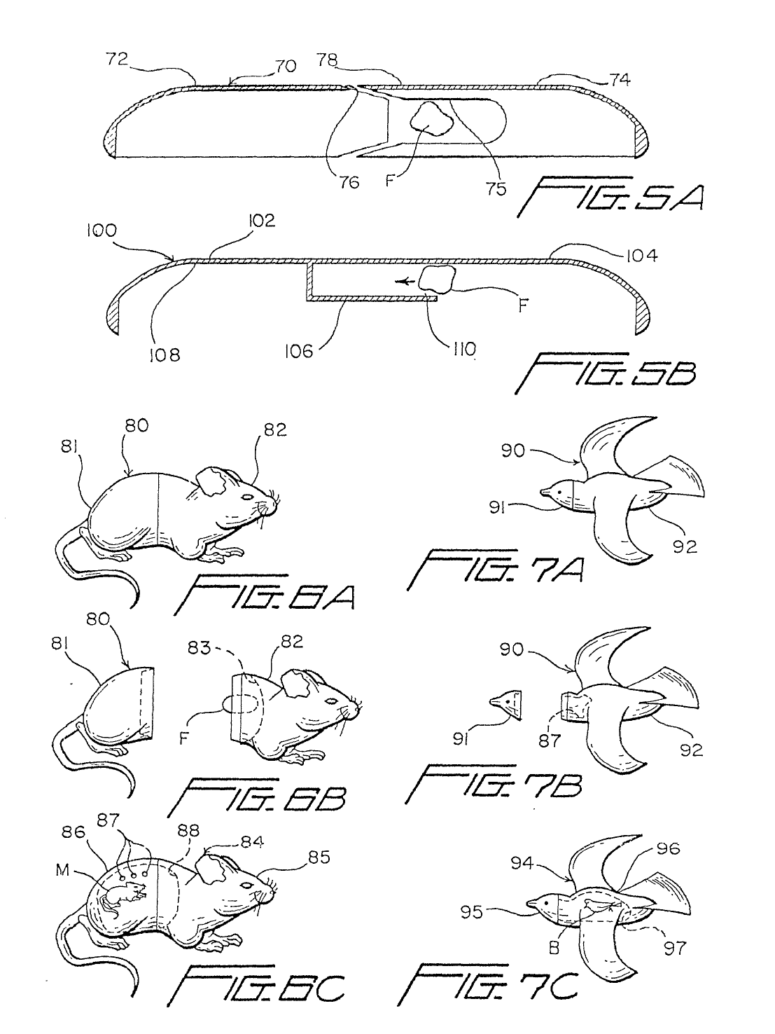

For particular animals a retrieval toy according to the present invention may be made to look like another creature which a particular animal eats. For example, FIGS. 6A and 6B show an artificial mouse 80 according to the present invention which is attractive to cats which has two releasably securable parts 81 and 82 with an interior chamber 83 for holding an item F. FIG. 6C shows an artificial mouse 84 with two releasably secured parts 85 and 86. Part 86 has air holes 87. A smaller artificial mouse or live mouse S is disposed in an inner chamber 88 of the mouse 84. The mouse 84 is made of transparent plastic so the live mouse may be seen.

FIGS. 7A and 7B show an artificial bird 90 with two releasably securable parts 91 and 92 with an interior chamber 87 for holding a food treat or other item. FIG. 7C shows an artificial bird 84 with two releasably secured parts 85 and 86. Part 86 has air holes 87. A smaller artificial bird or live bird B is disposed in an inner chamber 88 of the bird 84. The bird 84 is made of transparent plastic so the live bird may be seen. It is within the scope of this invention to provide a body of any animal shape with a smaller artificial or live animal therein, or to insert therein any of the items or treats previously described herein. With respect to those embodiments shown from only one side in the drawings, the other side is a mirror image of the side shown.

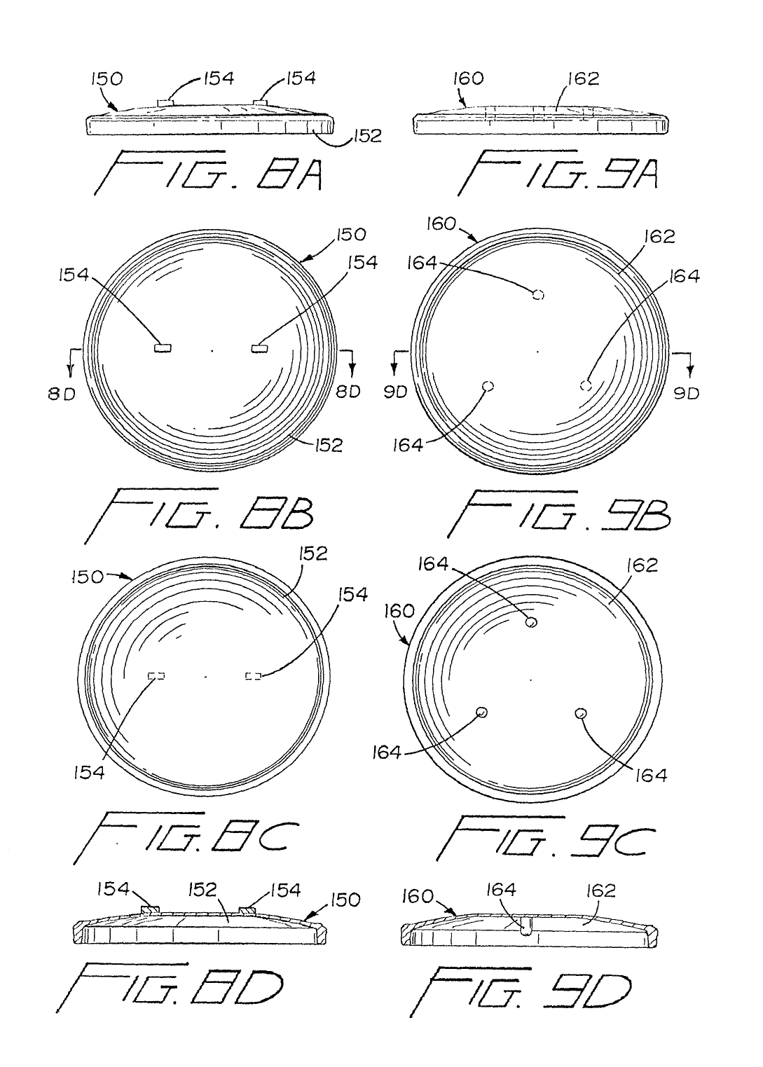

FIGS. 8A-8D show a throwing plate 150 according to the present invention with a body 152 and two upstanding posts 154. The posts 154 are shaped, sized, disposed, and configured for releasable receipt within a recess, opening, or slob in a toy, food item, container, game piece, game scoring indicator, food container, beverage container, replica of a food or beverage container (e.g., but not limited to a can of beer or carbonated drink), or other container (hereinafter referred to collectively as an “item” or “items”). The item is thus releasably mountable to or securable on the plate. It is within the scope of this invention to have one, two, three, four, or more of the posts 154 spaced apart on the body in any manner, in any pattern and/or with any desired spacing on the top, side, and/or bottom thereof, and, in one aspect, spaced so that the plate is balanced, It is also within the scope of this invention for the plate (and for any plate disclosed herein) to be any desired shape as viewed from the top or from the bottom, including, but not limited to a shape that is square, oval, circular, rectangular, triangular, pentangular, sexangular, septangular, octangular, etc.

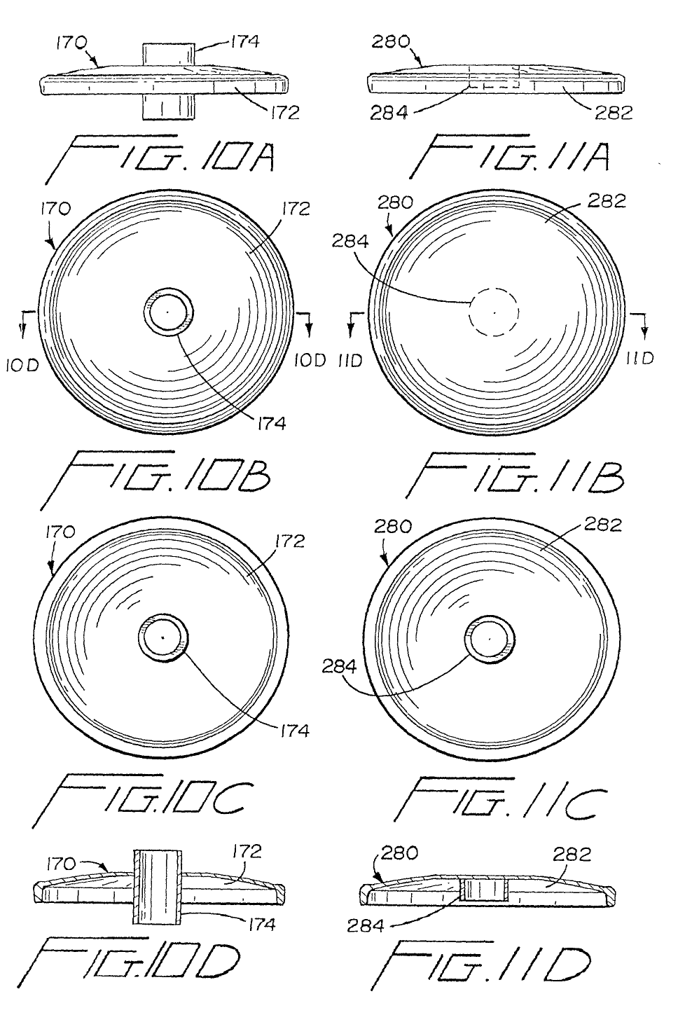

FIGS. 9A-9D show a throwing plate 160 according to the present invention with a body 162 and three downwardly projecting posts 164. The posts 164 are shaped, sized, disposed, and configured for releasable receipt within a recess, opening, or slot in a toy, food item, container, game piece, game scoring indicator, food container, beverage container, replica of a food or beverage container (e.g., but not limited to a can of beer or carbonated drink), or other container (hereinafter referred to collectively as an “item” or “items”). The item is thus releasably mountable to or securable on the plate. It is within the scope of this invention to have one, two, three, four, or more of the posts 164 spaced apart on the body in any manner, in any pattern and/or with any desired spacing on the top, side, and/or bottom thereof, and, in one aspect, spaced so that the plate is balanced.

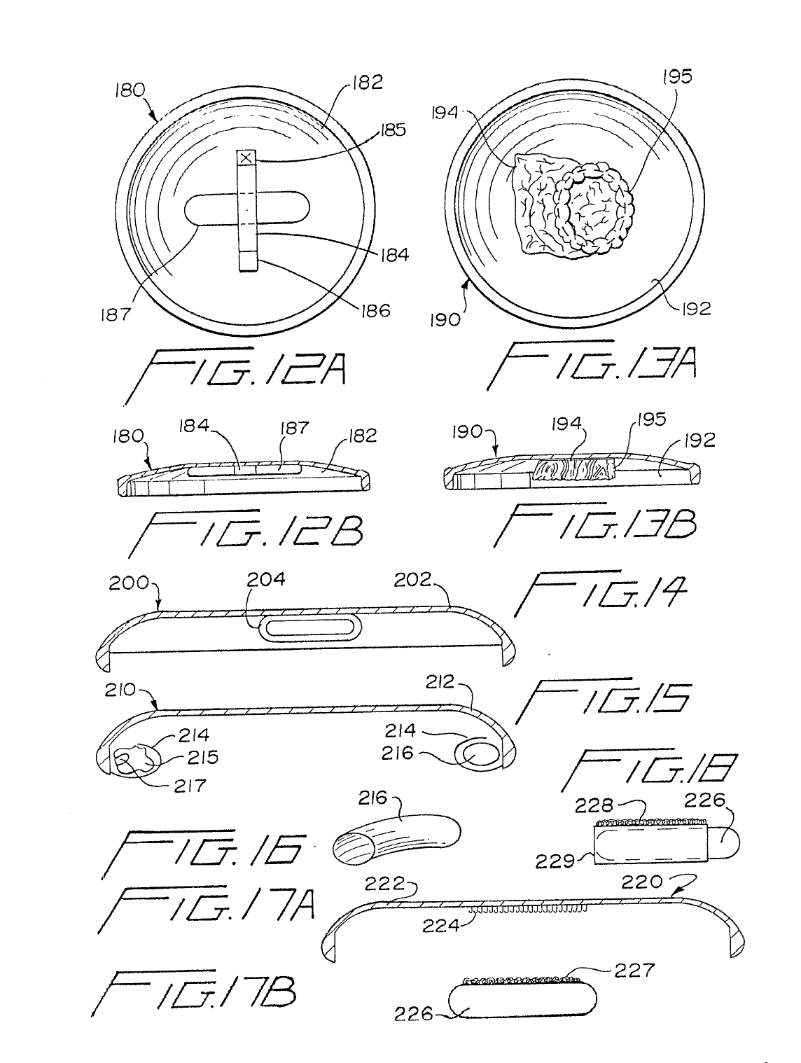

FIGS. 10A-10D show a throwing plate 170 according to the present invention with a body 172 with a hollow holder 174 extending therethrough. The hollow holder 174 releasably holds an item or items and is formed integrally of the body 172 or is secured to it, e.g. by suitable adhesives or tape. As shown, the hollow holder 174 is cylindrical, but it is within the scope of this invention for it to be any shape (as viewed from above or from below), including the shapes mentioned for the plate 150 and a shape corresponding to the shape of an item releasably held therein. Two, three, four or more of the holders 174 may be used with the plate 170 and they may be disposed on the top, bottom, and/or side thereof.

FIGS. 11A-11D show a throwing plate 280 according to the present invention with a body 282 with a hollow holder 284 extending therethrough. The hollow holder 284 releasasbly holds an item or items and is formed integrally of the body 282 or is secured to it, e.g. by suitable adhesives. As shown, the hollow holder 284 is cylindrical, but it is within the scope of this invention for it to be any shape (as viewed from above or from below), including the shapes mentioned for the plate 150 and a shape corresponding to the shape of an item releasably held therein. Two, three, four or more of the holders 284 may be used with the plate 280 and they may be disposed on the top, bottom, and/or side thereof. A removable cover or cap may be used on the open (lower) end of the hollow holder 284, and either or both ends of the hollow holder 174 may have such a cap or cover.

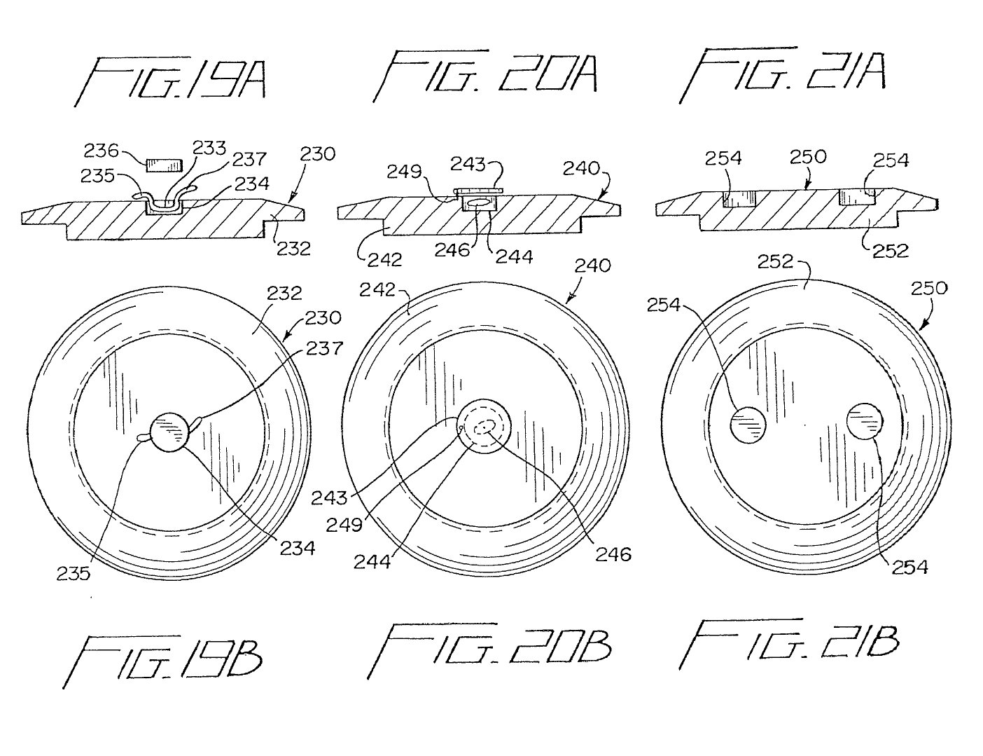

FIGS. 12A and 12B show a throwing plate 180 with a body 182 whose top view (not shown) is like that of the plate 150 without the posts 154, but whose bottom view shows a strap 184 with and end 185 fixed to the body 182 and an end 186 releasably connectible (e.g., with an adhesive, with releasably cooperating fastener material (e.g. hook and pile material), or with VELCRO (TM) material) to the body 182. It is within the scope of this invention for the strap 184 to be anywhere on the body 182 (top, bottom, side, any location); for there to be one, two, three, four, or more such straps; and for there to be one or more straps on different parts of the body (e.g. but not limited to one or two straps on the top and one or two straps on the bottom).

FIGS. 13A and 13B show a throwing plate 190 with a body 192 whose top view (not shown) is like that of the plate 150 without the posts 154, but whose bottom view shows a cloth or fabric pocket 194 with an openable/closable mouth 195. The pocket is fixed to the body 192 with any suitable adhesive or fasteners. The mouth 195 may have an expandable/contratable band such as a band of elastic material—shown stretched open in FIG. 13A. The pocket 194 may be releasably connected to the body 192, e.g., with adhesive, fasteners, and/or releasably cooperating fastener material, or with VELCRO (TM) material) to the body 182. It is within the scope of this invention for the pocket 194 to be anywhere on the body 192 (top, bottom, side, any location); for there to be one, two, three, four, or more such straps; and for there to be one or more pockets on different parts of the body (e.g. but not limited to one or two pockets on the top and one or two pockets on the bottom). The pocket 194 removalby holds an item or items.

FIG. 14 shows a throwing plate 200 according to the present invention with a body 202 to which is affixed a rubber band or flexible strip 204 for releasably holding an item or items. The band or strip 204 may be attached as the pocket 194 or strip 184 is attached or it may me attached by placing it through a hole or opening in the plate, and, if needed tying a knot or knots in the band or strip. The band or strip 204 may be releasably connected to the body 202, e.g., with adhesive, fasteners, and/or releasably cooperating fastener material, or with VELCRO (TM) material) to the body 202. It is within the scope of this invention for the band or strip 204 to be anywhere on the body 202 (top, bottom, side, any location); for there to be one, two, three, four, or more such bands ors strips; and for there to be one or more bands or strips on different parts of the body (e.g. but not limited to one or two bands or strips on the top and one or two bands or strips on the bottom). The band or strip 204 removalby holds an item or items.

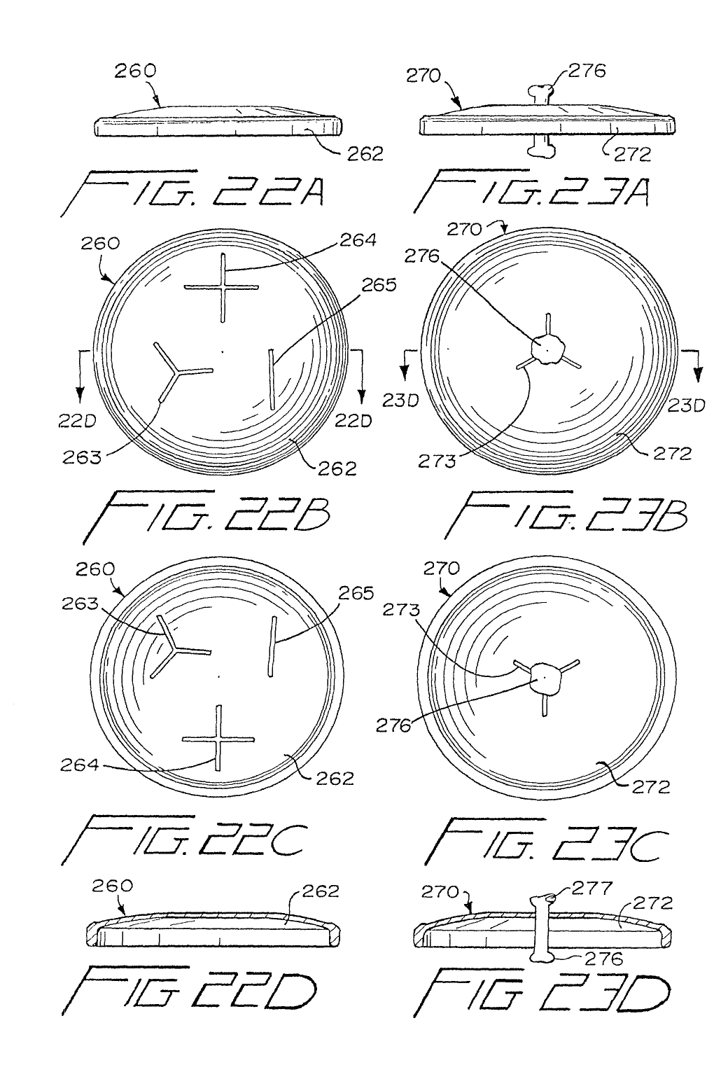

FIG. 15 shows a throwing plate 210 according to the present invention with a body 212 having an upturned lip 214 formed, disposed, and configured to releasably hold an item 215 and/or an item 216. The lip may be turned outwardly rather than inwardly as shown in FIG. 15. As shown, the lip 214 is flexible so that the item(s) are removable from the plate 210 by freeing them by moving the lip. The item 215 has a slot 217 for use with the projections or posts of the plates of FIGS. 8A and 9A. A similar slot may be used in any item disclosed herein. The lip 214 may be more rigid than shown and not extend back toward the plate body as much so that an item or items may releasably be held between the lip and the interior wall of the plate body and the item released without moving the lip. A lip 214 may used on the top of the plate 210, on the bottom (as shown), or on both. A portion of such a lip may be used anywhere on the body to releasably hold an item or items.

FIG. 16 shows the item 216. The item 216 may have a length such that it covers only a portion of the circumference of the plate 210 (as shown), or it may be sufficiently long to cover the entire circumference of the plate 210.

FIG. 17A shows a throwing plate 220 according to the present invention with a body 222 and releasably cooperating fastener material 224 on the bottom thereof. An item 226 (FIG. 17B) has corresponding releasably cooperating fastener material 227 so that it is releasable connectible to the body 222. The item 226 may be any item disclosed herein. In one aspect the item 226 is a food item, e.g. but not limited to, a dog biscuit or dog treat made so that part of the item to be consumed by the dog or animal is in the form of pieces, fibers, or fibrils which releasably mate with the material 224. It is within the scope of this invention to use the material 224 anywhere on the plate 220 and to use one, two, three, four, or more such pieces of material.

FIG. 18 shows a hollow container 229 with releasably cooperating fastener material 228 with an item 223 removably disposed therein. The hollow container 229 is releasably attachable to the material 224 of the plate 220 of FIG. 17A.

FIGS. 19A and 19B show a throwing plate 230 according to the present invention (like that of FIG. 4A) with a body 232 with a recess 234 therein for releasably receiving and holding an item 236. A flexible member 233 has an end 235 fixed to the body 232 and is positioned so that it is emplaceable in the recess 234 under the item 236 with a free end 237 projecting from the recess. Pulling on the free end 237 facilitates removal of the item 236 from the recess 234. The flexible member 233 may be any suitable cloth, string, wire, yarn, plastic, or rubber. Such a member 233 may be used with any recess for an item disclosed herein.

FIGS. 20A and 20B show a throwing plate 240 according to the present invention (like that of FIG. 4A) with a body 242 with a recess 244 therein for releasably receiving and holding an item 246. A movable cover 243 is pivotally pinned with a pin 249 to the body 242 permitting selective access to the item 246. Instead of a pinned cover, a soft or rigid cover may be adhesively and removably attached over the recess 244.

FIGS. 21A and 21B show a throwing plate 250 according to the present invention (like that of FIG. 4A) with a body 252 with a two recesses 254 therein for releasably receiving and holding an item (not shown). It is within the scope of this invention for their to be three, four, or more recesses 254 in the plate 250 or in any plate disclosed herein.

FIGS. 22A-22D show a throwing plate 260 with a body 262 according to the present invention. The body 262 is made of material sufficiently flexible and resilient so that an item may be inserted through and releasably held in slitted portions 263, 264 and 265. Any number of such slitted portions may be used positioned anywhere on the body 262, including in the top, bottom, and/or side thereof.

FIGS. 23A-23D show a throwing plate 270 with a body 272 according to the present invention. The body 272 is made of material sufficiently flexible and resilient so that an item 276 is inserted through and releasably held in a three-armed slitted portion 273. Any number of such slitted portions may be used positioned anywhere on the body 272, including in the top, bottom, and/or side thereof. The item 276 may have a slot 277 for use with the projections or posts of the plates of FIGS. 8A and 9A.

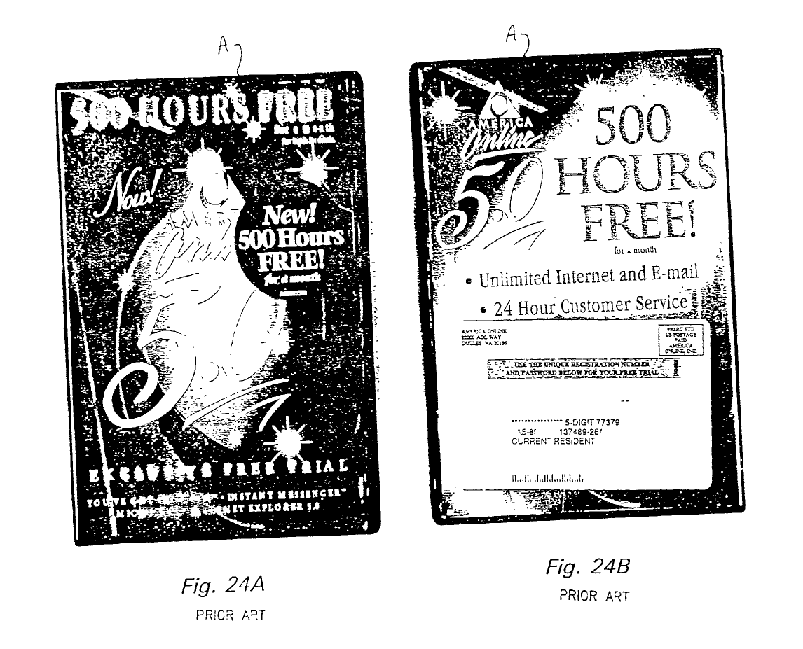

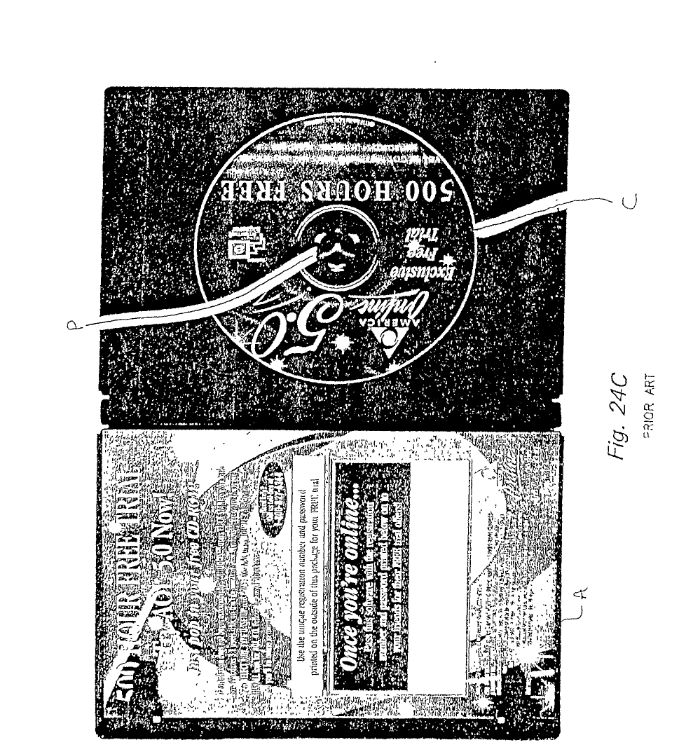

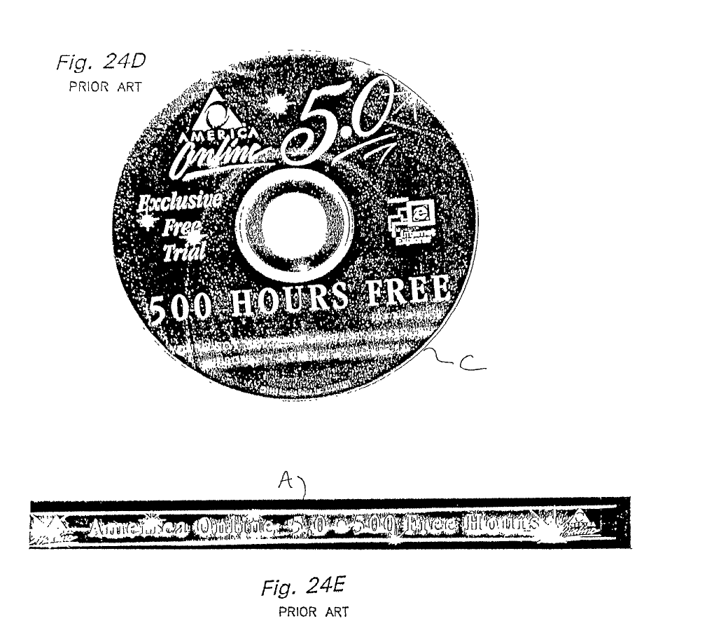

FIGS. 24A-24C and 24E show a prior art container for a CD-ROM disc C. Typical known prior art push-button apparatus P releasably holds the disc C in the container A.

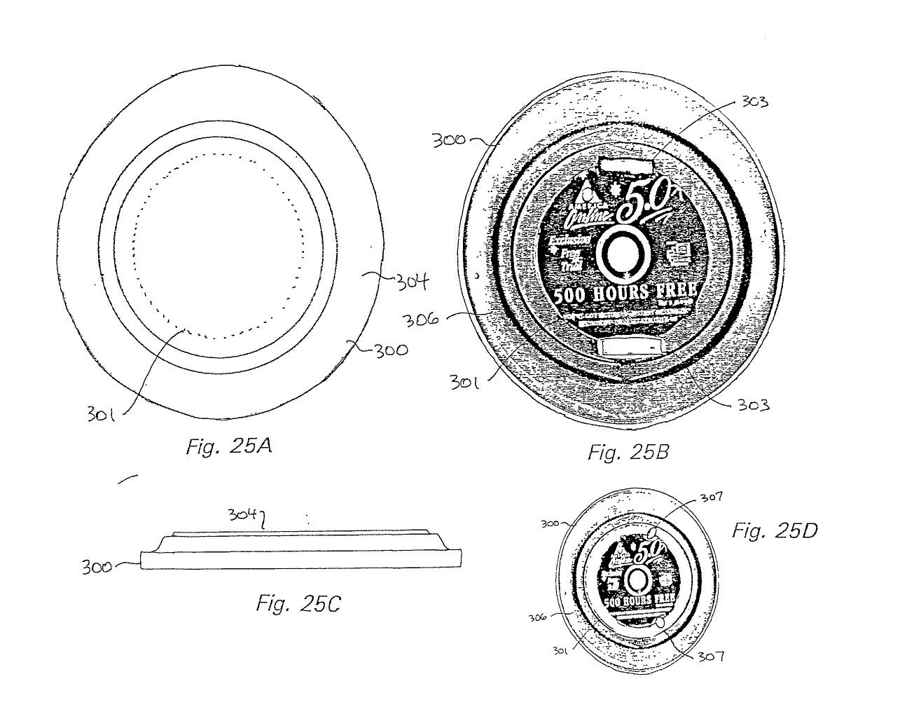

FIGS. 25A-25C show a flying disc 300 according to the present invention which includes a flying disc body 302 with a top 304 and a bottom 306. Releasably secured to the bottom 306 is a CD-ROM 301 with tape pieces 303. It is within the scope of this invention to releasably secure the CD-ROM disc 301 to the flying disc body 302 with any known tape, adhesive, glue, or suitable releasable securement apparatus or device. FIG. 25D shows another embodiment of the disc 300 with two movable or bendable tabs 307 holding the CD-ROM disc 301 in place on the bottom of the flying disc. It is to be understood that the disc body 302 may be any known flying disc, disc, Frisbee (TM) device, and any disc body disclosed herein. Also, the overall shape of the disc (and of any disc or disc body disclosed herein), as viewed from above may be any suitable shape, including, but not limited to, oval, circular, triangular, square, rectangular, pentagonal, hexagonal, septagonal, octagonal, nonagonal, etc.

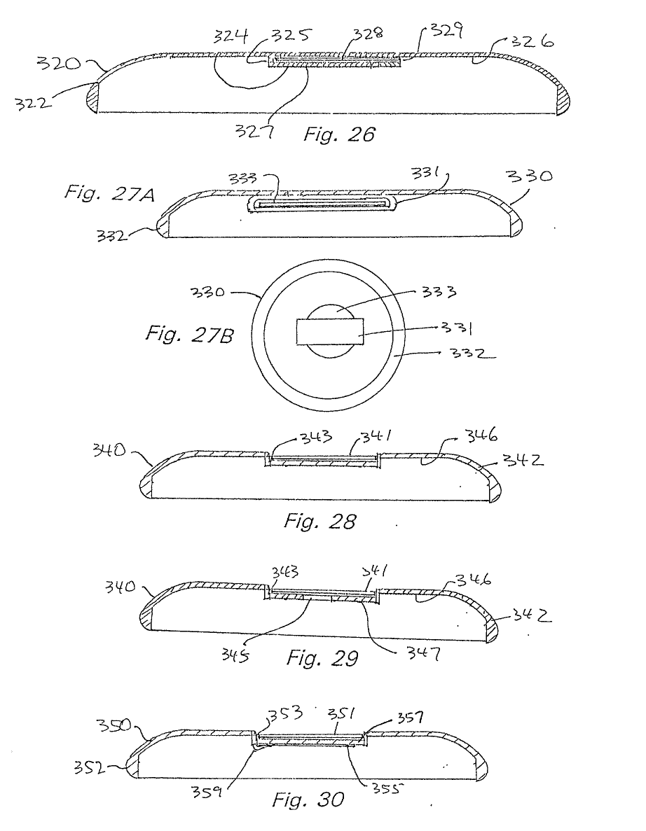

FIG. 26 shows a flying disc 320 according to the present invention with a disc body 322 and a chamber 324 formed of or secured to a bottom 326 of the disc body 322. The chamber 324 includes a side wall 325 and a lower wall 327 and it houses a CD-ROM disc 328 which is removable out through an open end 329. A chamber such as the chamber 324 may, according to the present invention, be provided on any disc body disclosed herein.

FIGS. 27A and 27B show a flying disc 330 according to the present invention with a disc body 332 and a sleeve 331 attached to or formed of the disc body 332. A CD-ROM disc 333 is releasably held by and within the sleeve 331. A sleeve like the sleeve 331 can, according to the present invention, be provided on any disc body disclosed herein.

FIG. 28 shows a flying disc 340 according to the present invention with a disc body 342 having a bottom 346 and a top 344 with a top recess 343 in which is releasably positioned a CD2 ROM disc 341. The CD-ROM disc 341 may be releasably held in the recess 343 with a friction fit and/or with any suitable tape, adhesive, tab(s), etc.

FIG. 29 shows another embodiment of the disc 340 of FIG. 28 with a hole 345 through a lower wall 347 that defines part of the recess 343. A finger or suitable object may be thrust through the hole 345 to facilitate removal of the CD-ROM disc 341 from the recess 343. A recess like the recess 343 and/or with a hole like the hole 345 may be provided on any disc body disclosed herein.

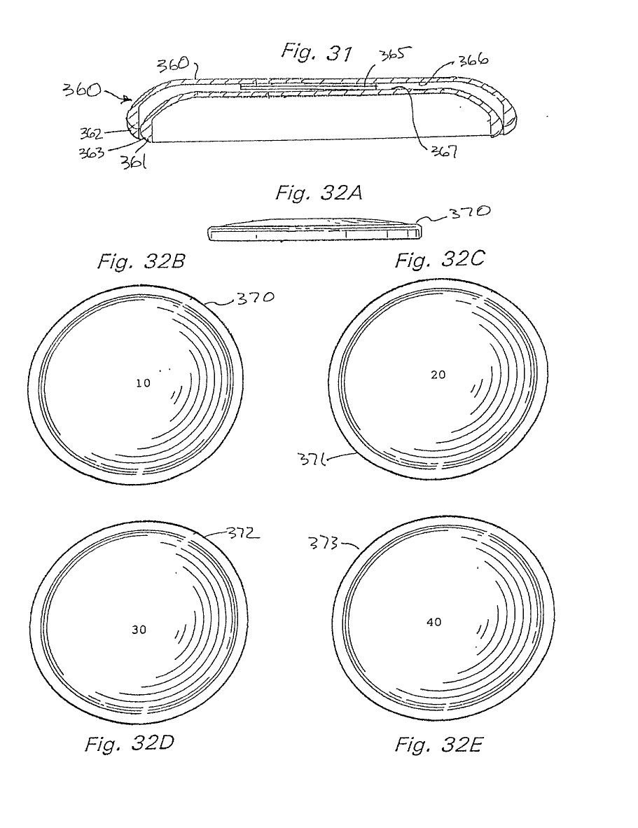

FIG. 30 shows a flying disc 350 according to the present invention with a disc body 352 and a recess 353 (like the recess 343) with a lower wall 357 (like the lower wall 347). A manipulable or bendable clip 359 releasably holds a paper booklet 355 on a lower surface of the wall 357. A CD-ROM disc 351 resides releasably within the recess 353. Alternatively, the clip 359 may hold a CD-ROM disc instead of or in addition to the booklet 355 and, in one such aspect, the recess 353 is deleted. Alternatively, two or more clips 359 may be used. Alternatively one, two or more clips 359 are positioned on top of the disc body 352 instead of or in addition to the one or more clips 359 on the bottom of the disc body. It is within the scope of this invention to provide one, two, three or more clips 359 on any disc body disclosed herein.

FIG. 31 shows an object containing a nesting combination of two flying discs, 360 and 361 (with disc bodies like the body 332, e.g.). The two discs are, in one aspect, releasably held together by a friction fit between the disc's lower edges 362, 363 respectively—either an air tight fit that prevents air flow between the two discs or a fit that does permit air flow bgetween them. An object, e.g. but not limited to a paper, a booklet, and/or a CD-ROM disc 365, is held between a lower surface 366 of the disc 360 and an upper surface 367 of the disc 361. It is within the scope of this invention to emplace any suitable object between the discs; to nest together any desired number of flying discs, e.g. one, two, three, four, five or more; and/or to nest together any discs of any shape disclosed herein which have a nestable shape.

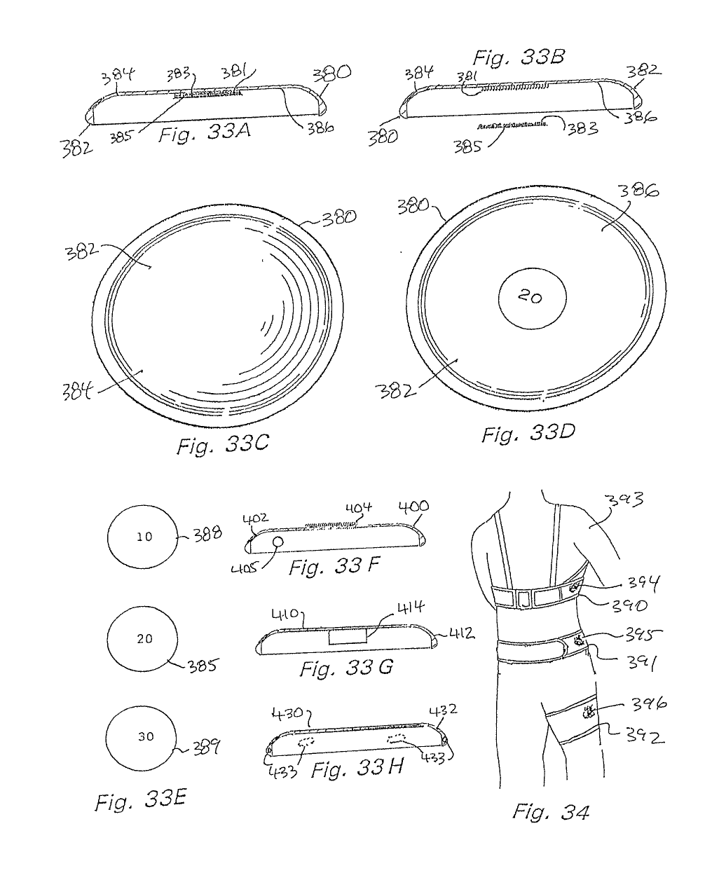

FIGS. 32A and 32B show a flying disc 370 according to the present invention which, as shown in FIG. 32B, bears the numeral “10” on its underside. FIGS. 32C-32E show additional discs 371-373 like the disc 370, but with different numerals. A plurality of discs such as those disclosed in FIGS. 32B-32E may be used, in one aspect according to the present invention, in a game in which one, two, or more persons (or a throwing apparatus) throw the discs at, (either simultaneously, randomly, or sequentially) to, or near one, two, three, four or more persons (players). The person or persons at whom the discs are thrown score points equal to the numeral on a disc they catch and/or for a disc they retrieve and/or acquire whether they catch it in the air or not. A game can be won in several ways: a player catches, retrieves, and/or acquires a sufficient number of discs to accumulate a pre-set point total; a player catches, acquires, and/or retrieves a disc with each different numeral; a player acquires, catches, and/or retrieves a set number of discs whose point values are in sequence; and/or a player catches, acquires, and/or retrieves a set number or a particular set of discs which then qualifies the player to proceed from the area to which the discs are being thrown to a pre-set base or goal, and whichever player first achieves the base or goal is the winner. Alternatively, the players not only get points for disc catching, acquisition and/or retrieval, they also earn points by then themselves throwing the discs at or into certain containers, goals, bases, or targets and score more points for their accuracy in such throwing. Any suitable scoring indicia may be used on the discs and any disc disclosed herein may have the indicia for use in a game according to the present invention. It is also within the scope of the present invention for players to be associated in teams for any game according to the present invention.

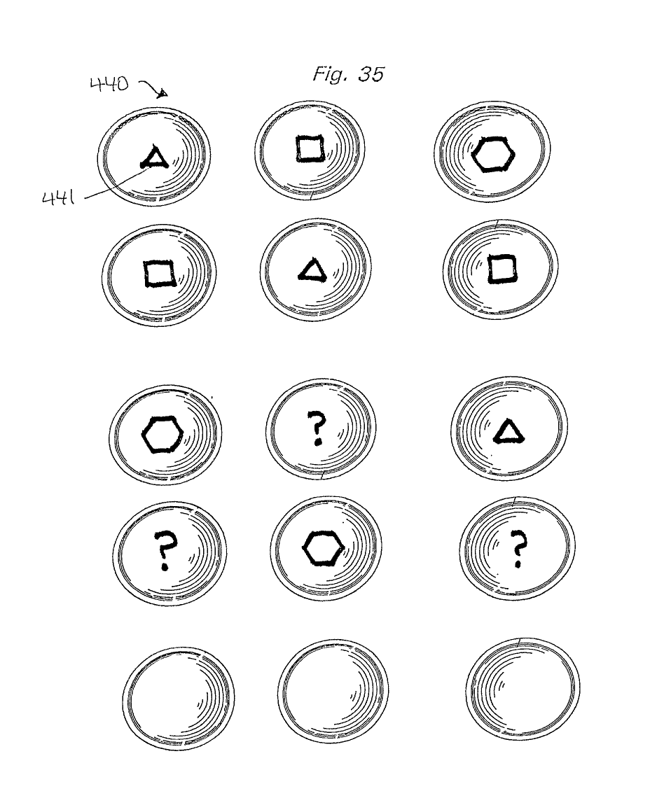

FIGS. 33A-33D show a flying disc 380 according to the present invention with a disc body 382 having a top 384 and a bottom 386. An amount 381 of releasably-cooperating or hook-and-loop fastener material is on the bottom 386 of the disc 380. Releasably secured to the material 381 is a patch 385 (e.g. of cloth, plastic, cardboard, paper, or other suitable material) 385 which has on its upper surface a corresponding amount of releasably cooperating or hook-and-loop fastener material 383 [including, but not limited to, VELCRO (TM) material]. As shown in FIG. 33D, the patch 385 has the numeral “20” on it. FIG. 33E illustrates a plurality of patches 388, 389 (like the patch 385) and 385 with different numerals on them. Patches shown have a generally circular shape, but may be any desirable shape.

A plurality of discs like the disc 380 with patches like the patch 385 may be used in any of the methods or games described herein.

FIG. 34 illustrates garments 390, 391 392 worn by a person 393, each garment having an amount of releasably-cooperating fastener material 394, 395, 396 respectively (like the material 381). In one particular activity or game according to the present invention, the person 393 upon catching acquiring and/or retrieving a disc like the disc 380, removes the patch 385 and releasably attaches it to one of the amounts of material 394, 395, 396. In one aspect another player may attempt to remove this patch to deny the person 393 of points associated with catching/retrieval of the disc that held the patch; the player taking the patch from the person 393 may be awarded those points himself or herself. Although specific garments are shown in FIG. 34, it is within the scope of this invention to provide material like the material 381 on any part of any garment, band or item of clothing or apparel (e.g. headband, wristband, ankleband, belt, hat strap and/or shoe). Any disc, any patch, and any item of clothing or garment may have a battery-powered light, a “light stick,” and/or fluorescent material thereon in any form to facilitate use of them in the dark. Material 381 and/or a patch like the patch 385 may be provided on any disc or disc body disclosed herein. It is within the scope of this invention for any patch like a patch 385 to be releasably held in place with suitable tape and/or glue. During a game or activity with one or more discs, each disc with one or more removable patches, a player may as appropriate during the game or activity, switch patches on discs and/or switch a patch from a garment to a disc prior to throwing the disc.

FIG. 33F illustrates a flying disc 400 according to the present invention which may be used with or without a patch like the patch 385. The flying disc 400 has a disc body 402 (like the body 382) with an amount 404 of releasably-cooperating fastener material on top of the disc. The disc 404 has indicia 405 thereon (which as with any indicia herein for any disc herein may be anywhere on the disc or disc body) which may be used for point scoring as in the games and activities described herein. The disc 400 itself may be releasably secured to an amount of material (like the material 383) on a garment, etc., as to the material amounts 394-396 of the garments 390-392 respectively (FIG. 34). Any flying disc or disc body disclosed herein may have an amount of material like the material 404, the amount of material may be located anywhere on the disc or disc body, and two, three or more of such amounts of material may be used (in one aspect at least one such amount for each disc required to win the game).

FIG. 33G shows a flying disc 410 with a disc body 412 (like the body 382) and a flotation member 414 secured to or formed of the body 412 that provides sufficient buoyancy to float the disc 410 when it is in water. Such a flotation member 414 may be made of any suitable buoyant material; may be hollow solid or hollow; and may be provided (with or without one or more air chambers 433 described below) on any flying disc or disc body disclosed herein. Thus, any game or activity according to the present invention with one or more flying discs according to the present invention may be conducted in a pool, lake, river, creek, stream, or in the surf.

FIG. 33H shows a flying disc 430 according to the present invention with one or more (as shown) air chambers 433 in a disc body 432 (like the body 382) that are large enough to provide sufficient buoyancy to float the disc 430 when it is in water. Such chamber(s) may be provided for any disc or disc body disclosed herein.

FIG. 35 illustrates a plurality of flying discs 440 many of which have a specific identifying indicia 441 (triangle, square, hexagon or question mark) and some, optionally, are “dummy” discs with no identifying indicia. Any indicia disclosed herein may be used anywhere on the disc bodies. Any game or activity disclosed herein may be played with the discs 440. In one aspect, one or more persons (individuals or on a team) throw the discs 440 (simultaneously, sequentially or randomly) to one or more persons (individuals or on a team). In one aspect a player wins by catching and/or retrieving a set of the discs, i.e., one disc with each different indicia and/or all discs with one particular indicia, e.g. all discs with triangle indicia. A player retrieving a disc that does not help that player achieve a desired set throws that disc away, in one aspect anywhere in a pre-agreed area or field of play, for other players to retrieve. Any particular indicia, e.g. those discs with a question mark indicia, may, optionally, be a “wild card” disc that may be used as a disc of any desired indicia to complete a desired set. Once a set is achieved a play wins; or, as described above for other games and activities, a player who accumulates a desired set may, to win, be required to get to a base, goal, etc. The dummy discs may be used a useless decoys of no point or set value. Such dummy discs (one or more) may be provided for any game or activity disclosed herein. The indicia may be provided on patches by providing the discs with one or more removable patches as described above.

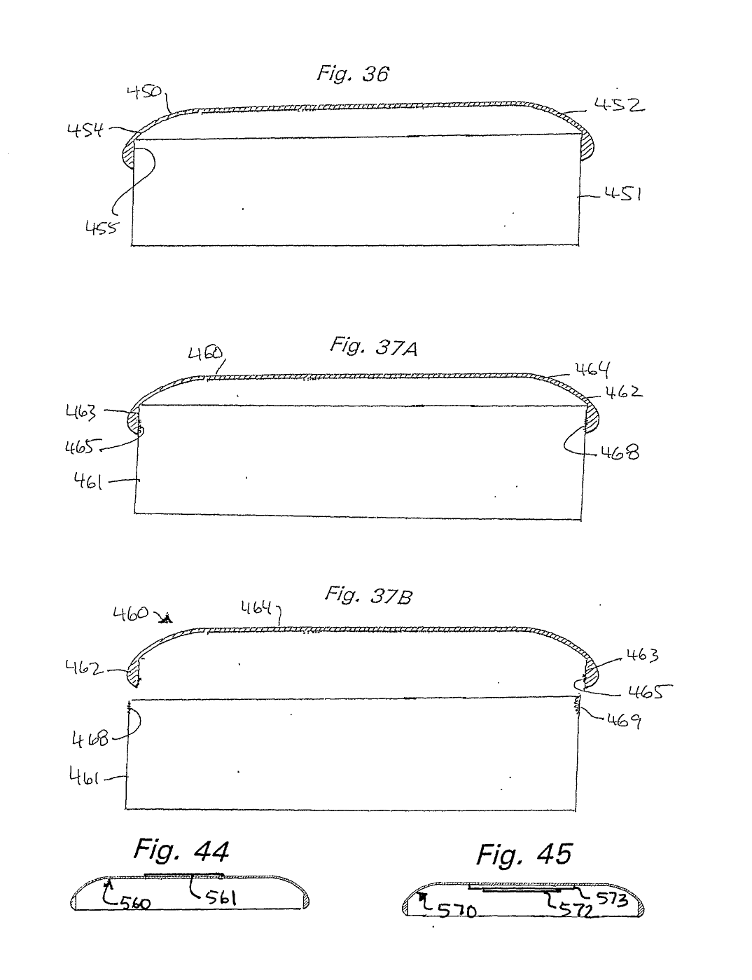

FIG. 36 shows a container 450 according to the present invention with a hollow container body 451 and a flying disc 454 with a disc body 452 (like the body 382, e.g.) as the removable lid. The lid-flying disc 454 is held in place on a top edge 455 of the container body 451 by a friction fit. The disc body 452 and the container body 451 may be any suitable dimensions for containing a desired item.

FIGS. 37A and 37B show a container 460 according to the present invention with a hollow container body 461 (like the container body 451) and a flying disc 464 with a disc body 462 (like the body 382) as the removable lid. The lid-flying disc 464 has an inner edge 4463 with threads 465 therearound. An edge 468 of the hollow container body 461 has threads 469 therearound for threaded mating of the flying disc 464 and the container body 461 (as shown in FIG. 37A). It is within the scope of this invention for the hollow container bodies in FIGS. 36 and 37A to have open bottom ends closed off by another flying disc releasably secured over the bottom opening. It is within the scope of this invention for any suitable disc disclosed herein to be used as the lid for the containers of FIGS. 36 and 37A.

Any flying disc described above for holding a CD-ROM disc may employ the know prior art “push button” structure for releasably securing a CD-ROM disc to a flying disc. Any CD-ROM disc, patch, buoyancy member, paper booklet, and/or clip disclosed herein may be located on any location on a disc body, including, but not limited to, as centrally shown herein. In one aspect a non-central location imparts a desired imbalance to a disc so it will fly more erratically and unpredictably.

In any game or activity described herein in which a group of players or team accumulates a pre-determined score and/or a pre-determined number of discs or indicia-bearing members and/or a predetermined set of discs or indicia-bearing members, the team can choose, in certain aspects, one player (or some designated players) to hold the discs or indicia-bearing members as they are accumulated during the game or activity (or to have these items releasably attached to the designated player's clothing, garment, belt, hat, strap, shoe, band, or apparel, etc). The identity of the designated player ( or in one aspect two or more designated players) may be revealed at the start of the game or at some pre-set point during the game. Alternatively, the identity of the player(s) may be kept secret until the pre-determined score, number of indicia-bearing members, or set is achieved; or until the player(s) attempt to move to a pre-determined base, goal, or target to “win” the game or activity. In one aspect a player or players may, in any such game or activity according to the present invention, attempt to take from an opposing player (who has qualified to move to a base, goal or target) a disc or discs or an indicia-bearing member so that player no longer is qualified to advance to the base, goal or target.

In any game or activity according to the present invention a pre-determined time limit may be imposed on a player or players for achieving a predetermined score and/or for retrieving a predetermined disc or plurality of discs.

Any patch or other indicia-bearing member disclosed herein may be releasably attached to a flying disc with well-known snap apparatus or with the well-known press-fit pop-free apparatus used to releasably attach plastic “flags” to belts used in flag football. In one particular aspect a flying disc itself has the press-fit pop-free apparatus and the disc itself, once retrieved, is releasably attached to a belt or garment with corresponding apparatus (e.g. but not limited to the well-known flag football belt with corresponding apparatus).

In any game or activity according to the present invention in which a score is accorded a person or team for retrieving a disc, a higher score may be awarded for retrieving a disc in flight as opposed to a disc which has touched the ground or water.

Any CD-ROM or any flying disc according to the present invention may include on the CD-ROM instructions and/or rules for any game or activity according to the present invention, information for contacting the source of the game, activity, and/or disc; and/or a computerized version of any game or activity according to the present invention.

The present invention, therefore, provides in certain, but not necessarily all embodiments, a method for at least one first person to interact with at least one second person, the method including the at least one first person throwing a plurality of flying discs, each of the plurality of flying discs bearing identifying indicia, and the at least one second person retrieving at least one of the plurality of flying discs. Such a method may have one, some, or all of the following: wherein the at least one second person is a plurality of second persons; the plurality of second persons competing with each other to retrieve flying discs thrown by the at least one first person; wherein the plurality of second persons comprises at least two separate competing teams, each team including a plurality of persons; wherein the at least one first person is a plurality of first persons; wherein the plurality of first persons comprises a first team and a plurality of second persons comprises a second team; wherein a time taken by the at least one second person to retrieve some, all or at least one of the plurality of flying discs is measured as a time score for the at least one second person; wherein the at least one second person is a plurality of second persons and each of the plurality of second persons who retrieves some, all or at least one of the plurality of flying discs receives a time score corresponding to the time taken to retrieve said disc and/or a numerical score corresponding to numerical indicia on the discs retrieved; wherein the first team throws the plurality of flying discs to the second team and time taken by the second team to retrieve some, one, or at least a portion of the plurality of flying discs is measured and is a time score for the second team and/or numerical score corresponding to numerical indicia on the discs retrieved; wherein the second team then throws a plurality of flying discs to the first team and time taken by the first team to retrieve at least a portion of the plurality of flying discs is measured and is a time score for the first team and/or the first team receives a numerical score corresponding to numerical indicia on retrieved discs; wherein a predetermined numerical score is to be achieved by a winning team or a pre-determined set of flying discs is to be retrieved by a winning team and the method further comprising the at least one first person throws the plurality of flying discs to at least two separate competing teams, each of the at least two separate competing teams attempt to retrieve flying discs, and the separate competing team that first achieves the pre-determined numerical score or acquires the pre-determined set of flying-discs is the winner; wherein for a separate competing team to be declared the team winner, at least one member of said team becomes a designated member and must have flying discs indicative of the pre-determined numerical score or the pre-determined set of flying discs and said member must move to a pre-selected base with said discs or said patches; wherein a member of an opposing team may attempt to remove at least one of said discs or said patches from said designated member; wherein at least one disc of the plurality of flying discs bears its indicia by bearing an indicia-bearing member releasably attached to the at least one disc; wherein the at least one second person wears a garment (hat, strap, clothing, belt, apparel etc.) and the indicia-bearing member is releasably attachable to the garment; wherein at least one of the plurality of flying discs is releasably attachable to a garment worn by the at least one second persons; wherein the at least one second person receives a score for retrieving at least one of the plurality of flying discs; and/or for any activity or game according to the present invention wherein a score is higher for retrieving a thrown flying disc in flight as opposed to a disc which after throwing touches ground or water before being caught or

Any game or competition described herein may, according to the present invention, be played or competed in with a barrier, wall or net that separates either: a throwing area from which flying disc(s) are thrown and a receiving area or scoring area to which the discs are thrown; or two competitor or team areas one on each side of the net. Such a net includes, but is not limited to, a net as used in volleyball, tennis, badminton and ping-pong and such a game or competition may be played on a traditional court or table associated with each of these nets or games or on a basketball court. In certain aspects a disc receiving area on one side of a wall, barrier or net (within a structure or outdoors) may be divided into two, three, four, five, six or more scoring areas each associated with scoring a particular numerical score, providing a multiplier for multiplying a numerical score indicated on a flying disc landing in the area, and/or with scoring a hit for landing int hat particular area. A wall, barrier, or net as described above may be over or across a swimming pool or part of a pool or over or across a body of water or part thereof. The wall, barrier or net may be any desired height above the ground or above water and provision may be made of a space between a lower edge of the wall, barrier or net and a top surface of the ground or water. In certain aspects throwing a disc through such a space disqualifies the disc and in other aspects a thus thrown disc scores either points or for traversing that space, the flying discs used for such games and activities (as is true of any disc herein) may be sized as desired. In one aspect relatively small discs (e.g. between 1 to 5 inches in diameter) would be sued in playing with a net on a ping pong table.

In certain particular aspects of any game or activity according to the present invention, a catching apparatus or obstruction apparatus may be used by a defensive person to thwart the efforts of a person or persons throwing one or more discs at a target, etc. and/or to score points or hits in any way disclosed herein. In one particular aspect the catching apparatus has an amount of releasably cooperating fastener material (e.g. but not limited to known hook-and-loop materials and Velcro™ material) which can mate with and thereby catch and hold a flying disc that has a corresponding amount of such releasably cooperating fastener material. Points or other types of a score can be scored for catching such a disc with such a catching apparatus. Such a catching apparatus may, according to the present invention, be (but is not limited to) a glove, racquet, cesta, stick, panel, piece of rigid material, or another flying disc. Alternatively, a defender may use a net such as those used to catch butterflies and insects or to land a fish to thwart a thrown disc and/or to score by netting it. In another aspect a water gun, water pistol, or any water jetting apparatus may be used by a defender (in any game, competition or activity disclosed herein) to prevent a thrown flying disc from hitting a target, etc. or landing in a desired scoring area.

Any game, activity, or competition according to the present invention that requires throwing a disc to hit a particular target, etc. or land on a particular area may be played on a traditional soccer field, basket ball court, football field, etc., with the soccer goals, baskets, uprights, etc. serving as a target or disc landing areas for scoring purposes. In certain activities according to the present invention, e.g. those played on a soccer field, football field or basketball court, one player of group of players defends and tries to prevent another player or group of players from scoring, e.g. but not limited to, by throwing a flying disc or plurality of discs into a soccer goal, between football field uprights, or through a basketball net. In one aspect of such an activity a team or player to win throws a certain number of discs or accumulates a certain total score based on scoring indicia on discs; or in one aspect each of a plurality of players throws a flying disc to score in order for the team to win.

Any game, competition, or activity according to the present invention may be timed or certain individual scoring attempts or series of scoring attempts may be tried with no scoring permitted when time is up. Alternatively in certain aspects a person is timed in scoring a certain number of points or a certain type and/or number of scoring events and the player who achieves a predetermined score wins.

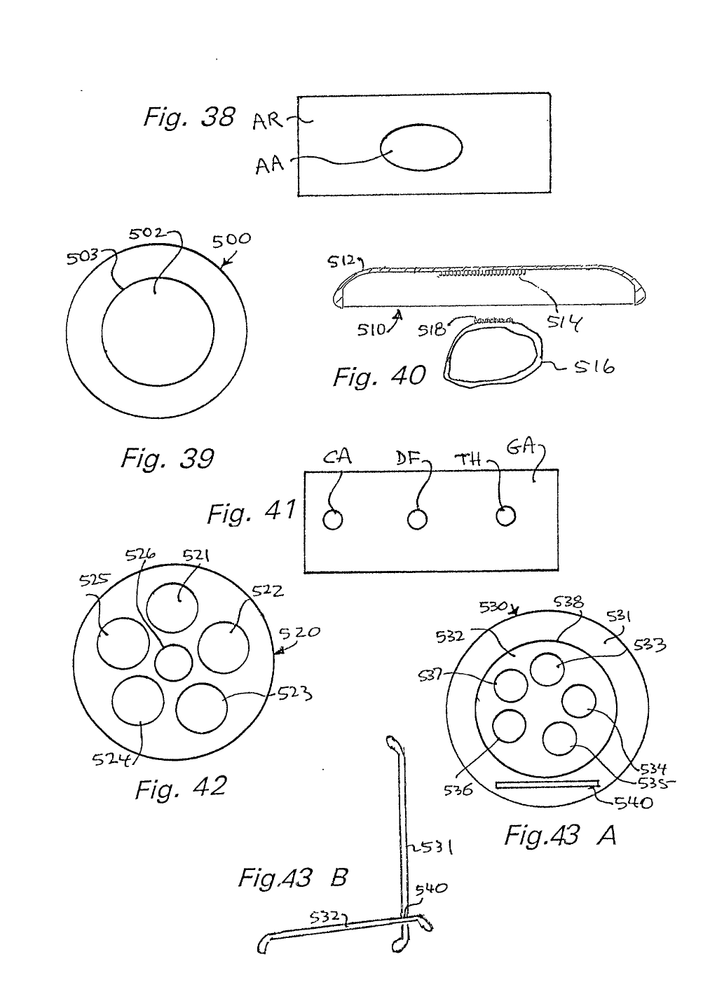

FIG. 38 shows schematically an area AR into which or onto which one or more flying discs are to be thrown to score. Such an area AR may have one or more specific areas AA for enhanced scoring as compared to area AR; or a score may be possible only for a flying disc landing in area (or areas) AA. The areas AR and/or AA may also have targets or containers therein for scoring or for enhanced scoring; for example, but without limitation, an area AR has three areas AA, each with a container and the three containers are marked “10”, “20”, and “30” respectively. A person or team that throws a plurality of flying discs, each with a specific numerical value on the disc, lands a disc marked “10” in the container marked “20” for a score of 10×20 or 200 and a disc marked “50” in the container marked “30” for a score of 50×30=1500 and a total score of 1700.

Any game played in an area as in FIG. 38 can be played with an offense seeking to score and a defense attempting to prevent the offense from scoring. In certain aspects the defense is limited in position and cannot be in the areas AA and/or cannot be within a certain distance of a target, container, etc. Such a game, with or without a defense, may, in certain aspects, be played in a gymnasium, in a stadium, or in or around a swimming pool. In another aspect two players or teams situated around a gym, field, or pool simultaneously throw one or a plurality of flying discs in an attempt to score. In one particular such game according to the present invention, a class of forty students is divided into two twenty person teams and each person is given a flying disc. Color, numerals, letters or other identifying indicia distinguishes one team's flying discs from the other's. Each team enters an area or stands on opposite sides of a scoring area, e.g. but not limited to a designated area on the gym floor. On a given signal all players throw their discs. Total score is based on a team's discs landing in the scoring area. In one aspect, no disc throwing is permitted when a certain time interval has expired. In another aspect instead of a gymnasium such an activity is conducted indoors or outdoors around a track, a football field or swimming pool. with a swimming pool one or more movable targets, containers, or scoring areas may be used in or on the water. In non-pool situations a moving target, etc. (or plurality thereof) may be provided by placing a target, etc. on a wheeled apparatus.

In another embodiment of an activity according to the present invention one or more discs (any disclosed herein) are used to hit scoring areas on a panel or wall. Scores may be tabulated manually or the scoring areas may have mechanical or electronic sensors and indicators for signalling and indicating a score. Audio and/or visual signals and/or indicators may be used.

The present invention also discloses various solitaire games in which a plurality of flying discs according to the present invention, any disclosed herein, are thrown by a single person at a target, container, scoring area, goal etc. to achieve a particular total score, or to hit a certain number of targets etc., or targets, etc. in a predetermined series.

FIG. 39 shows a flying disc structure 500 which has a removable portion 502. Upon removal of the removable portion 502, a hole 503 that remains is sized so that the flying disc structure 500 can be worn as a hat, sunvisor, or headgear. The removable portion 502, optionally, may also be configured as a flying disc. The flying disc structure 500 may be shaped and fashioned like any disclosed herein. optionally the removable portion 502 is shaped as a flying disc and the remainder of the structure 500 is not. Any suitable tie, string or elastic band may be used to hold the disc structure 500 on a wearer's head (the tie, etc. e.g., but not limited to, glued, or taped to the structure 500 and/or passing through one or more holes therein). Any flying disc herein may thus be made into headgear.

FIG. 40 shows a headgear 510 according to the present invention which has a top part 512 which is a flying disc (e.g., but not limted to, like that of FIG. 33A or FIG. 17A) which has an amount of releasable cooperating fastener material 514 may be connected an elastic member 516 which has an amount 518 of releasably cooperating fastener material matable with the amount 514. The elastic member 516 releasably holds the headgear 510 on a person's head by emplacing the elastic member around a person's head with part under the person's chin. string, ties, straps, etc may be used instead of the member 516. Any flying disc herein may be used for such headgear.

Any container or other structure used in any activity, game, or competition according to the present invention may have one or more openings therein or therethrough through which a flying disc is to be thrown for scoring purposes. In other aspects, one or more discs situated in or on a target, area, container, etc. may not be retrieved and subsequently thrown until a certain score is achieved at the initial target, etc.

FIG. 41 illustrates schematically a game area GA for a game or activity according to the present invention in which one or more (e.g., two, three, four, five, six, ten, etc.) throwers TH throw a disc or discs (with any indentifying and/or scoring indicia thereon as disclosed herein) to a catcher (or catchers) CA. One or more defenders DF attempt to prevent the catcher(s) CA from catching the thrown discs. In one aspect points or scores are achieved only when a disc is caught before it hits the ground surface, floor surface or water surface of the area GA. In one aspect no player may exit the game area during a game.

Any disc disclosed herein may have one or more off-center member(s) whose weight causes the disc to fly in an erratic and/or non-straight path.

In another embodiment a flying disc 520 as shown in FIG. 42 has one or a plurality of smaller flying discs 521-526 (each of the same size or of different sizes) which are releasably held in corresponding holes or recesses 531-536 in or through the flying disc 520. In one aspect, the flying disc 520 with the smaller discs 521-526 is made as an integral structure from which the smaller discs may be popped-out, cut out, and/or removed. Appropriate openings, recesses, and/or weakened or thin parts are provided around the discs 521-526 to make them easily removable from the disc 520. (Such structure is also used to make the portion 502 removable from the disc structure 500 in FIG. 30.) Alternatively a lip on a small disc 521-526 may be releasably held in a corresponding groove or recess of the disc 520; or the smaller discs 521-526 are held on corresponding holes by a friction fit.

FIGS. 43A and 43B disclose a flying disc system 530 according to the present invention which has a flying disc 532 which is initially held releasably in a hole or recess 538 in an outer flying disc 531. A plurality of smaller flying discs 533-537 are releasably held in corresponding holes 539 in the disc 532. Any of the discs 521-526 (FIG. 42) or the discs 532-537 may be a compact disc, CD, or other computer disc. In one aspect the discs 533-537 are thrown at the hole or recess 538 to score. As shown in FIG. 43B the disc 531 may have a slot or holding structure 540 into which the disc 532 (or some other member) is insertable to stand the disc 531 upright to present a target at which the discs 533-537 may be thrown. A score is also possible, in certain aspects, if the disc 531 is knocked over. The discs in FIGS. 42 and 43 may have any identifying and/or scoring indicia disclosed for any disc herein. (“CD-ROM Discs” includes compact discs).

The following “WHIZ-IT” (TM) games are games played with one or more flying discs according to the present invention as disclosed herein.

WHIZ-IT JIM GAME

The WHIZ-IT JIM Game can be played: (1.) by individuals; (2.) by one team competing at a time; (3.) by two teams competing with each team able to score simultaneously; or (4.) by two teams competing simultaneously while only one of the two teams can score—with one team on offense and one team on defense.

The WHIZ-IT JIM Game may be played in any suitable area which can be subdivided to include an area from which a flying disc is thrown; an area over which the flying disc passes in flight (and/or on which it rolls and/or bounces); and a “scoring” area (labelled “SCORE”) in which, if the disc comes to rest there, the person (or team) throwing the disc scores.

The WHIZ-IT JIM Game can be played on any suitable playing area; including but not limited to a football field; a soccer field, a swimming pool area; or in a gymnasium with a suitable scoring and/or target area marked off or demarcated, including, but not limited to, in the center of the field or area of play. Alternatively, multiple (two, three, four or more) score areas may be used. Alternatively, the score area and/or target area may include a target, goal, sheet, board, or container into which, onto which, or through which a disc must pass and/or come to rest to score. One or more such targets, etc. can be used for an enhanced score or score multiplier (e.g., scoring on this target may be doubled, tripled, etc., or a specific number of points may be added for scoring on it).

As one example of a WHIZ-IT JIM Game, a typical high school physical education class is divided into two teams, e.g. a “Red” Team (“R's”) and a “Yellow” Team (“Yps”)

The teams alternate on offense and defense, with the R Team on offense and the Y Team on defense. The members of the R Team standing in the bleachers, stands, floor, or seating area around a gym, field, area, or pool (or on only one or two sides thereof) and attempt to throw flying discs onto the “SCORE” area marked off in the center of the gym (e.g. either marked off with paint or a rope; or indicated by a tarp, cloth, sheet, paper, canvas, or tape—e.g., laying in the center of the gym, etc.). The Y Team attempts to intercept the discs thrown by the R Team or to knock them away from the “SCORE” area. Once all the R Team discs have been thrown (and there may be a pre-set time period during which all of a team's discs must be thrown—as is possible in all WHIZ-IT JIM Games), the teams switch so that the Y Team goes on offense and the R Team goes on defense. Once a disc lands in and/or comes to rest on or in a target, etc., it may not be moved.

### WHIZ-IT VOLLEY GAME

Two teams of any desired number (or two individuals) of players are positioned with one team on a court or playing area on one side of a net (or barrier) and the other team on the other side of the net (or barrier). Each team—e.g. the “Red” Team (“R”) and the “Yellow” Team (“Y”) has six members on opposite sides of a typical volley ball net on a typical volleyball court (although any typical play area or net/court game configuration may be used, including, but not limited to tennis net/tennis court and badminton net/badminton court). Also, a barrier of any kind and desired height may be used, not limited to a rope or string at a certain height across the area, walls, nets or netting.

Each R Team player and each Y Team player may have a flying disc and the object of the game is to throw a disc over the net (or barrier) and have it land on the opposing team's playing area. The members of the opposing team defend their play area on their side of the net (or barrier) by trying to prevent the other teams' flying discs from landing on their play area.

If agreed upon by the teams, a defending player can score if a disc thrown by an opposing player is caught in the air by the defending player before it touches the defender's play area.

### WHIZ-IT FUN GAME

Two teams of any desired number of players, e.g., but not limited to two teams, Red Team and Yellow Team, each with seven players (“Y” indicates Yellow team member; “R” indicates red team member). The playing field has two ends and may be rectangular, square, oval or any suitable shape. A team goal is at each end of the field; e.g. as shown in FIG. A, the Red Goal of the Red Team is at one end of the field and the Yellow Goal of the Yellow Team is at the other end of the field.

A team scores by landing a flying disc within its goal (e.g., but not limited to, a soccer net-type goal) or by throwing a flying disc through the goal (e.g. the space beneath the cross bar and between the uprights of a U.S. football goal). Members of an opposing team may guard the other team's goal and try to prevent the other team's flying discs from scoring by catching a disc thrown by an opposing team member or by deflecting such a disc.

A “throw” line in front of each goal marks a boundary beyond which a player may not throw a disc at the player's team goal in an attempt to score. All discs thrown in an attempt to score must be thrown further from the goal than the throw line.

Either any player may be a “throwing” player who attempts to score or teams may agree that only a certain number of players can score. Further, teams may agree that only certain players designated before play commences can score. Teams agree on how many players (e.g., one, two, three, four, or more) can defend a goal.

The field may have any desired dimensions and the “throw” lines may be any agreed distance from the goals. The “throw” lines may be 25 yards in front of the goal. Also, half of a field may be used with only one goal with teams taking turns as offense—“throwing” scoring team—and defense—guarding the goal and trying to prevent the other team from scoring.

As agreed upon between the teams a defending team can be required to position its players in front of a “defense” line at a certain distance from the goal and no closer to the goal than this distance. For example, the line in front of each goal can be a defense line with a radius of about ten yards in front of a goal.

The teams may play (as in any game herein) for a certain predetermined time period; until one team reaches a certain predetermined score; and/or until one team reaches a certain predetermined score and is a certain number of points ahead of the other team.

Teams may (as in any game herein) score a point for each disc that enters a goal; and/or points as designated by point indicating indicia on a disc.

Any suitable goal, target, sheet, paper, scoring area marked off on the ground (or floor or pool surface), or container may be used as the “goal” for purposes of scoring.

### WHIZ-IT SOL GAME

The WHIZ-IT SOL Game is played by an individual with a plurality of flying discs either (1.) to achieve a cumulative point total score within a certain pre-set number of thrown discs; (2.) in as few throws as possible to score a pre-set number of points, the final “score” being the number of throws; (3.) to score at least once with respect to each of a pre-set plurality of goals or targets; or (4.) to score by throwing each of a plurality of sets of discs into corresponding goals—e.g. four each of red, yellow, blue and green discs into goals of corresponding colors.

For any game herein, any suitable flying disc or flying plate may be used—including, but not limited to, flying discs according to the present invention or prior art flying plates or flying discs.

FIG. 44 shows a flying disc 560 with a CD 561 attached thereto. The CD 561 may be attached by any suitable tape, adhesive or glue, securement apparatus disclosed herein, or it may be shrink-wrapped on the disc 560. Although the CD is shown on the top of the disc 560, it may on the underside thereof.

FIG. 45 shows a flying disc 570. Attached thereto is a CD 572 which is shrink-wrapped to (or otherwise attached and/or connected to) a cardboard piece 573 (or other suitable support, e.g., of kraft paper, plastic sheet, etc.) . This combination of a CD and piece of cardboard is then attached to the disc 570 by any suitable tape, adhesive or glue, securement apparatus disclosed herein, or the combination itself may be shrink-wrapped on the disc 570. Although the combination CD/cardboard-piece is shown on the underside of the disc 570, it may be on the top side. It is within the scipe of this invention to thus combine a CD and any flying disc disclosed herein.

The following are trademarks: WHIZ-IT; WHIZ-IT JIM; WHIZ-IT VOLLEY; WHIZ-IT FUN; and WHIZ-IT SOL.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112.

What is claimed is:

1. A flying disc comprising
a disc body and
a computer disc on the disc body.

2. The flying disc of claim 1 wherein the computer disc is a compact disc.

3. The flying disc of claim 1 further comprising
securement apparatus on the disc body for releasably securing the computer disc to the disc body,
the computer disc releasably secured to the disc body by the securement apparatus.

4. The flying disc of claim 1 wherein the disc body has a recess therein for holding the computer disc and the computer disc is releasably emplaced in the recess.

5. The flying disc of claim 4 further comprising
the recess having a lower wall, and
a hole through the lower wall, the hole disposed beneath the computer disc, the hole suitable for insertion of a member therethrough to facilitate ejection of the computer disc from the recess.

6. The flying disc of claim 1 further comprising
a support member on the disc body for supporting the computer disc,
the computer disc releasably disposed in the support member.

7. The flying disc of claim 6 wherein the disc body has a top side and a bottom side and the support member is on the bottom side.

8. The flying disc of claim 1 further comprising
at last one clip on the disc body for releasably holding an item.

9. The flying disc of claim 8 wherein the item is the computer disc.

10. The flying disc of claim 8 wherein the item is paper material.

11. The flying disc of claim 10 wherein the paper material is a booklet.

12. The flying disc of claim 1 wherein the disc body has a recess therein for holding the computer disc and the computer disc is releasably emplaced in the recess,
at last one clip on the disc body for releasably holding an item.

13. The flying disc of claim 6 wherein the support member is a sleeve with two open spaced-apart ends.

14. The flying disc of claim 6 wherein the support member is a chamber suitable for housing the computer disc, the chamber with a side wall extending down from an underside of the disc body and a bottom wall with an end connected to the side wall.

15. The flying disc of claim 3 wherein the securement apparatus is from the group consisting of tape, adhesive and glue.

16. The flying disc of claim 1 wherein the disc body as viewed from above, has a shape from the group consisting of oval, circular, triangular, square, rectangular, pentagonal, hexagonal, septagonal, octagonal, and monagonal.

17. A flying disc system comprising
a first disc body, the first disc body comprising a first flying disc,
at least one first opening through the first disc body,
at least one second disc,
the at least one second disc body releasably disposed in the at least one first opening.

18. The flying disc system of claim 17 wherein the at least one second disc body comprises a second flying disc.

19. The flying disc system of claim 17 wherein the at least one second disc body is a computer disc.

20. The flying disc system of claim 17 wherein the at least one first opening is a plurality of spaced-apart first openings, and
the at least one second disc body is a plurality of second disc bodies, one second disc body in each of the first openings of the plurality of spaced-apart openings.

21. The flying disc system of claim 20 wherein each second disc body has identifying indicia thereon.

22. The flying disc system of claim 17 further comprising
at least one secondary opening through the at least one second disc body, and
at least one secondary disc body releasably disposed in the at least one secondary disc opening.

23. The flying disc system of claim 22 further comprising
reception apparatus on the first disc body for receiving and releasably holding a support device for supporting the first disc body in an upright position.

24. The flying disc system of claim 23 wherein the support device is the at least second disc body and part of the at last one second disc body is releasably held in the reception apparatus.

25. The flying disc system of claim 22 wherein the at least one secondary disc body is a secondary flying disc.

26. The flying disc system of claim 25 wherein the at least one secondary disc body is a plurality of secondary disc bodies.

27. The flying disc system of claim 26 wherein each secondary disc body has identifying indicia thereon.

28. The flying disc system of claim 26 wherein the plurality of secondary disc bodies is a plurality of flying discs.

29. A flying disc system comprising
a first flying disc,
a second flying disc nested within the first flying disc, and
a computer disc disposed between the first flying disc and the second flying disc.

30. Any invention disclosed herein.
